(19) United States
(12) Patent Application Publication
(10) Pub. No.: US 2026/0217346 A1
(43) Pub. Date: Jul. 30, 2026

(54) ENHANCING SAFETY IN AN ELECTRIC MARINE VESSEL USING INDEPENDENT FAULT DETECTION LOOPS IN A POWER DISTRIBUTION UNIT

(71) Applicant: VISION MARINE TECHNOLOGIES, BOISBRIAND (CA)

(72) Inventor: XAVIER MONTAGNE, LAVAL (CA)

(21) Appl. No.: 19/037,500

(22) Filed: Jan. 27, 2025

(51) Int. Cl. B63B 79/30; B60L 3/00; B60L 15/00; B63H 21/17

(52) U.S. Cl. CPC B63B 79/30; B60L 3/0046; B60L 15/007; B63H 21/17; B60L 2200/32; B60L 2210/10

(57) ABSTRACT

Various embodiments relate to a Power Distribution Unit (PDU) for an electric marine vessel, comprising first, second, and third contactors that electrically couple a PDU power bus to a first battery, a second battery, and a marine propulsion system, respectively. The PDU implements independent fault detection loops for each connection: a first loop with the first battery, a second loop with the second battery, and a third loop with the marine propulsion system. Each contactor is automatically placed in an open state in response to a fault detected in its respective loop, ensuring isolation of the fault without requiring intervention from a control system. This configuration enhances safety and reliability by autonomously managing electrical faults, thereby preventing potential damage to the vessel's power systems and reducing the risk of human injury.

### FIELD OF THE TECHNOLOGY

The present disclosure relates to methods, apparatus, and products for enhancing safety in an electric marine vessel using independent fault detection loops in a power distribution unit.

### BACKGROUND

Advances in battery technology have paved the way for full-electric vehicles. Building on those advances, technology to enable full-electric watercraft has been widely adopted. However, the challenges of designing electric vehicles are different from the challenges of designing electric boats. The transformation of existing watercraft platforms to a full-electric platform also poses a different set of challenges. A particular challenge faced by electric watercraft is the danger of inoperable components. For example, a boat owner may attempt to use a battery or outboard motor that is not designed for operation with a particular electric boat. Such inoperability can cause the battery to overheat, catch fire, and even explode.

### SUMMARY

According to embodiments of the present disclosure, various methods, apparatuses, and computer program products for enhancing safety in an electric marine vessel using independent fault detection loops in a power distribution unit are described herein. In some aspects, a PDU includes first, second, and third contactors that electrically couple a PDU power bus to a first battery, a second battery, and a marine propulsion system, respectively. The PDU implements independent fault detection loops for each connection: a first loop with the first battery, a second loop with the second battery, and a third loop with the marine propulsion system. Each contactor is automatically placed in an open state in response to a fault detected in its respective loop, ensuring isolation of the fault without requiring intervention from a control system. This configuration enhances safety and reliability by autonomously managing electrical faults, thereby preventing potential damage to the vessel's power systems. In a particular example, the electric marine vessel is a recreational electric boat and the marine propulsion system is a full-electric outboard motor powered by high voltage (e.g., 400V or more) batteries.

In an embodiment, a PDU includes one or more first contactors configured to electrically couple a PDU power bus to a first battery. The PDU also includes one or more second contactors configured to electrically couple the PDU power bus to a second battery. The PDU also includes one or more third contactors configured to electrically couple the PDU power bus to a marine propulsion system. A first fault detection loop is implemented by the PDU and the first battery. The one or more first contactors are placed in an open state in response to a fault in the first fault detection loop. A second fault detection loop is implemented by the PDU and the second battery. The one or more second contactors are placed in an open state in response to a fault in the second fault detection loop. A third fault detection loop is implemented by the PDU and the marine propulsion system. The one or more third contactors are placed in an open state in response to a fault in the third fault detection loop. The first fault detection loop, the second fault detection loop, and the third fault detection loop are independent of one another

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1A sets forth a block diagram of an example electric marine vessel in accordance with at least one embodiment of the present disclosure.

FIG. 1B sets forth a block diagram of an example marine propulsion system of an electric marine vessel in accordance with at least one embodiment of the present disclosure.

FIG. 1C sets forth a block diagram of an example high voltage battery of an electric marine vessel in accordance with at least one embodiment of the present disclosure.

FIG. 1D sets forth a block diagram of an example power distribution unit in accordance with at least one embodiment of the present disclosure.

FIG. 1E sets forth a block diagram of an example vessel control unit of an electric marine vessel in accordance with at least one embodiment of the present disclosure.

FIG. 2A sets forth a block diagram of an example security management module for authenticating powertrain components of an electric marine vessel in accordance with at least one embodiment of the present disclosure.

FIG. 2B sets forth another example of the security management module of FIG. 2A.

FIG. 3 sets forth a block diagram of an example battery pack for enhancing safety in an electric marine vessel using independent fault detection loops in a power distribution unit in accordance with at least one embodiment of the present disclosure.

FIG. 4 sets forth a detailed view of an example signal interface of an example battery pack for enhancing safety in an electric marine vessel using independent fault detection loops in a power distribution unit in accordance with at least one embodiment of the present disclosure.

FIG. 5 sets forth a block diagram of an example system for enhancing safety in an electric marine vessel using independent fault detection loops in a power distribution unit in accordance with at least one embodiment of the present disclosure.

FIG. 6 sets forth a block diagram of another example system for enhancing safety in an electric marine vessel using independent fault detection loops in a power distribution unit in accordance with at least one embodiment of the present disclosure.

FIG. 7 sets forth a block diagram of an example marine propulsion system for enhancing safety in an electric marine vessel using independent fault detection loops in a power distribution unit in accordance with at least one embodiment of the present disclosure.

FIG. 8 sets forth a flow chart of an example method for enhancing safety in an electric marine vessel using independent fault detection loops in a power distribution unit in accordance with at least one embodiment of the present disclosure.

FIG. 9 sets forth a flow chart of another example method for enhancing safety in an electric marine vessel using independent fault detection loops in a power distribution unit in accordance with at least one embodiment of the present disclosure.

FIG. 10 sets forth a flow chart of another example method for enhancing safety in an electric marine vessel using independent fault detection loops in a power distribution unit in accordance with at least one embodiment of the present disclosure.

FIG. 11 sets forth a flow chart of another example method for enhancing safety in an electric marine vessel using independent fault detection loops in a power distribution unit in accordance with at least one embodiment of the present disclosure.

FIG. 12 sets forth a flow chart of another example method for enhancing safety in an electric marine vessel using independent fault detection loops in a power distribution unit in accordance with at least one embodiment of the present disclosure.

### DETAILED DESCRIPTION

Advances in battery technology have paved the way for full-electric vehicles. Building on those advances, technology to enable full-electric watercraft has been widely adopted. However, the challenges of designing electric vehicles are different from the challenges of designing electric boats. The transformation of existing watercraft platforms to a full-electric platform also poses a different set of challenges. A particular challenge faced by electric watercraft is the danger of the accidental disconnection of components to a power distribution unit (PDU). For example, a high voltage cable between the PDU and the motor may be disconnected during a crash. The cable is still hot, in that it is still electrically connected to the high voltage batteries. This poses a risk of human injury in trying to rescue the boaters or recover the boat.

The present invention relates to a PDU for an electric marine vessel, featuring a PDU power bus connected to first and second batteries and a marine propulsion system via respective contactors. The PDU includes independent fault detection loops for each battery and the propulsion system, ensuring that PDU contactors for those components are automatically and independently opened upon fault detection without requiring a control system. Additionally, a DCDC converter is integrated with the PDU power bus, accompanied by a fourth fault detection loop. This loop triggers the opening of all contactors upon fault detection, enhancing safety and reliability. The design ensures that each fault detection loop operates independently, allowing for targeted isolation of faults and maintaining operational integrity of unaffected systems. The PDU's automatic response to faults provides a robust solution for managing power distribution and fault isolation in electric marine vessels.

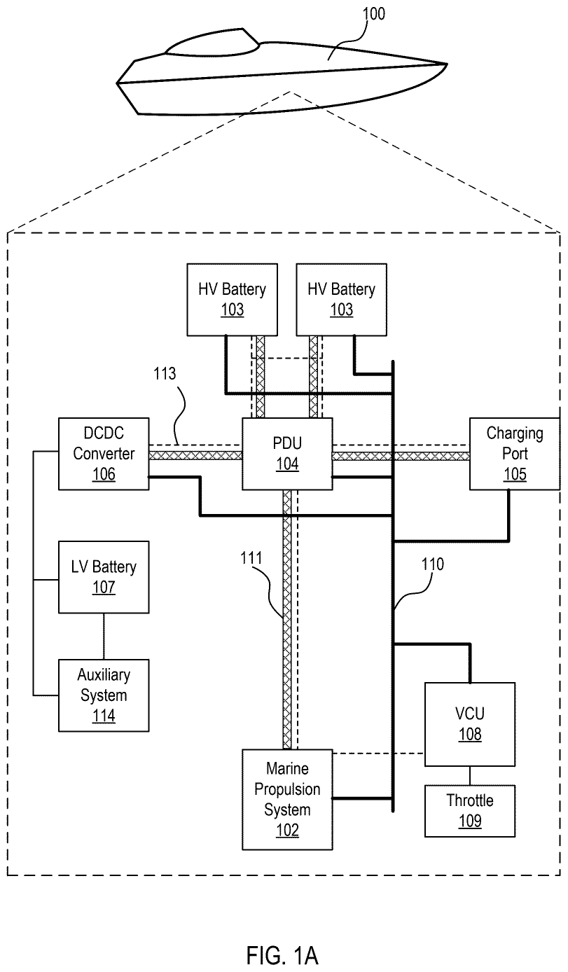

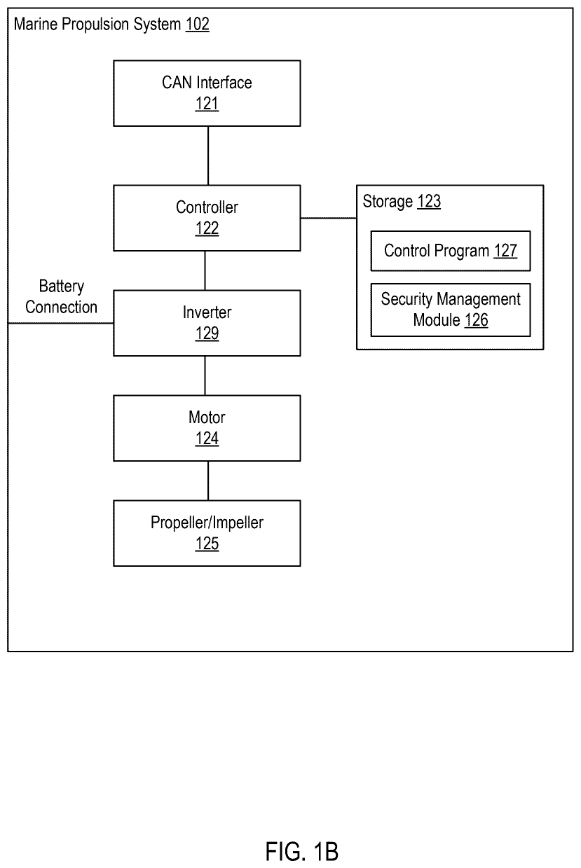

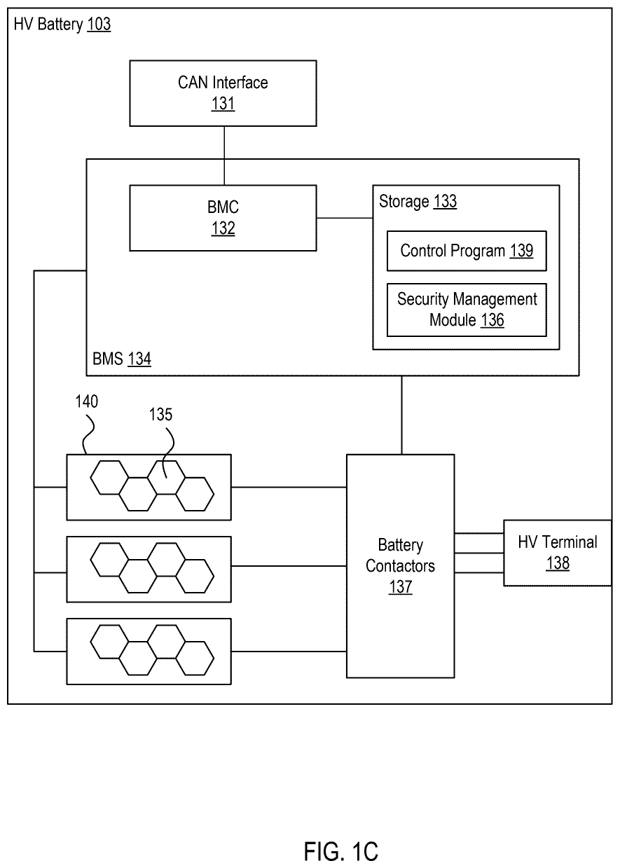

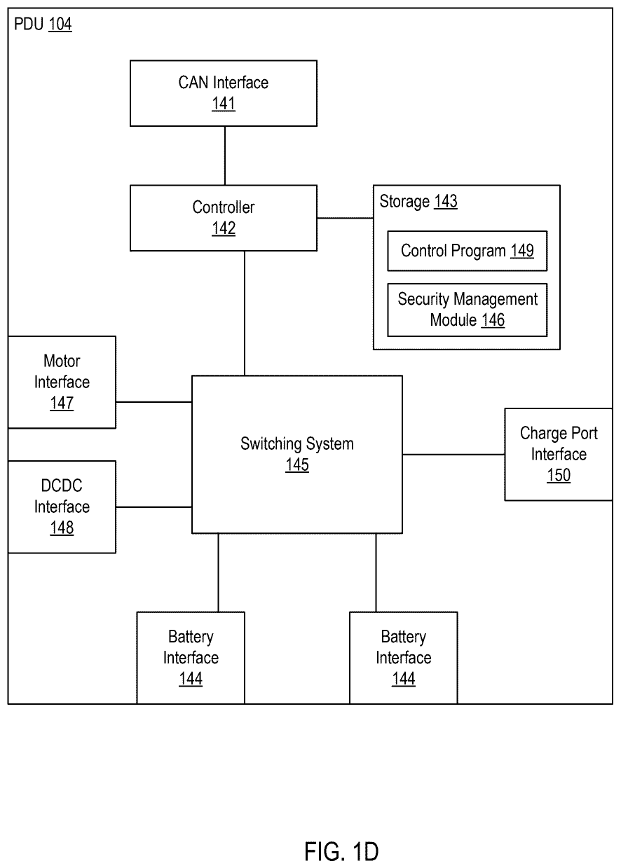

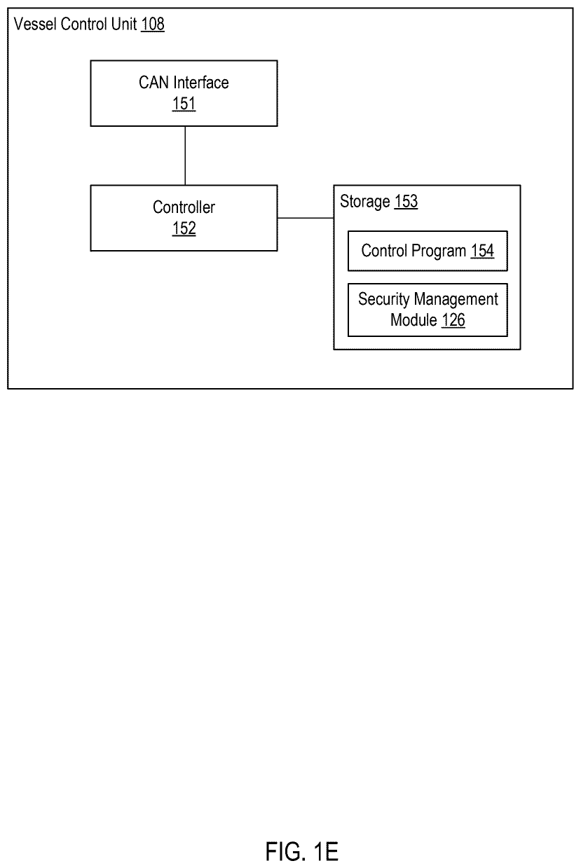

FIG. 1A sets forth an example electric vessel 100 for authenticating powertrain components of an electric vessel by a battery management controller in accordance with the present disclosure. FIG. 1A is provided to emphasize the powertrain components of vessel 100. It will be appreciated that vessel 100 may include other components not shown or described herein. Vessel 100 may be any type of watercraft. In a particular example, vessel 100 includes a full-electric powertrain and thus may also referred to as an ‘electric boat.’ To that end, vessel 100 includes a marine propulsion system 102. The marine propulsion system is described in more detail below with reference to FIG. 1B. In a particular example, vessel 102 is a recreational electric boat and marine propulsion system 102 is a full-electric outboard motor powered by high voltage (e.g., 400V or more) batteries.

The marine propulsion system 102 is powered by one or more high voltage batteries 103. In the example, of FIG. 1A, two high voltage batteries 103 are shown; however, it will be appreciated a vessel 100 in accordance with the present disclosure may include fewer or more high voltage batteries. High voltage batteries operate at voltages ranging from a few hundred to over 800 volts, depending on the design and application. Higher voltages allow for more efficient power transmission and reduced current flow, which helps minimize energy losses. Each high voltage battery 103 includes multiple modules, each containing several individual battery cells connected in series and parallel configurations to achieve the desired voltage and capacity. These cells may be arranged in a pack that optimizes space utilization and facilitates thermal management. Each high voltage battery 103 includes or is coupled to a battery management system (BMS). The BMS is responsible for monitoring and controlling various parameters such as voltage, current, temperature, and state of charge (SoC) of individual cells within the pack. The BMS helps optimize battery performance, protect against overcharging or over-discharging, and ensures safety. The BMS communicates with other vessel components about battery state, receives commands to change the battery state, and controls the opening and closing of the main contactors in the battery. The high voltage battery 103 is described in more detail below with reference to FIG. 1C.

The marine propulsion system 102 receives power from the high voltage battery 103 via a power distribution unit (PDU) 104. The PDU 104 receives high-voltage DC power from the high voltage batteries 103 and routes it to different subsystems and components within vessel 100, such as the electric marine propulsion system 102 and other subsystems such as a DCDC converter 106. The PDU 104 also couples the high voltage batteries 103 to a charging port 105 for charging the high voltage batteries 103. The PDU 104, as explained in more detail below with reference to FIG. 1D, includes a set of contactors that are controlled by logic or software in the PDU 104 to ensure safety when switching the flow of power among various vessel components.

The DCDC converter 106 provides voltage conversion capabilities to step down the high-voltage DC power to lower voltages required by an auxiliary system 114, such as the 12-volt electrical system used for lights, accessories, and onboard electronics. The DCDC converter 106 may be used to charge a lower voltage battery such as a 12-volt marine battery 107.

Vessel 100 further includes a vessel control unit (VCU) 108. Vessel control unit 108 serves as the central control unit responsible for managing and coordinating various functions and systems onboard the vessel 100. For example, the vessel control unit 108 can provide propulsion control, including regulating engine speed, torque, and direction to achieve desired propulsion performance and maneuverability in accordance with commands or signals received from the vessel's throttle control 109. The vessel control unit 108 can also manage the vessel's steering system. The vessel control unit 108 can also control startup/shut down routines, control charging/operation mode selection, control the opening and closing of contactors in the PDU 104, monitor the state of onboard systems, perform vessel diagnostics, and interface with an operator dashboard. To that end, the vessel control unit 108 may communicate with the other vessel powertrain components (e.g., the marine propulsion system 102, the high voltage battery 103, the PDU 104, the DCDC converter 106, and so one) via a control area network (CAN), referred to herein as a CAN bus 110. The vessel control unit 108 will be described in more detail below with reference to FIG. 1E.

The CAN bus 110 may be a two-wire serial bus that allows multiple components and devices within a vessel to communicate with each other without a host computer. The CAN bus 110 may use a message-based communication scheme where components and devices send and receive data in the form of messages. Each message includes a CAN identifier (CAN ID), data bytes, and control bits. The CAN bus 110 may employ a multi-master architecture, in that any device on the network can initiate a message transmission. This distributed architecture allows for efficient communication between vessel components without the need for a centralized controller. In a particular example, the CAN bus 110 may implement the NMEA2000 protocol, a standard set forth by the National Marine Electronics Association. NMEA2000 provides optimization and messaging for a marine environment.

Vessel 100 can also include a high voltage interlock loop (HVIL) system, which is a safety feature designed to ensure the safe operation and maintenance of the high-voltage components. HVIL is a dedicated circuit that ensures the high voltage connectors are well inserted in the equipment mating connector to ensure the safety of the high voltage connections. HVIL is used by the high voltage battery BMS and the vessel control unit 108 to confirm the integrity of these connections before applying high voltage energy to each high voltage device in the vessel.

For ease of reference, in FIG. 1A power interconnects 111 supplying high voltage power are shown in hash-filled lines, data interconnects for CAN bus 110 are shown in thick solid black lines, and HVIL interconnects 113 are shown in dashed lines.

For further explanation, FIG. 1B sets forth a block diagram of an example of the electric marine propulsion system 102 in accordance with at least one embodiment of the present disclosure. The example marine propulsion system 102 of FIG. 1B includes a CAN interface 121 for coupling the marine propulsion system 102 to the CAN bus 110. For example, the CAN interface 121 may be a network interface controller configured to send and receive messages in the form of CAN frames over the CAN bus 110.

The example marine propulsion system 102 also includes a controller 122 coupled to the CAN interface 121. The controller 122 may include or implement a processor, a microcontroller, an Application Specific Integrated Circuit (ASIC), a programmable logic array (PLA) such as a field programmable gate array (FPGA), or other data processing unit in accordance with the present disclosure. In some examples, the controller is implemented by a processor or central processing unit configured to execute computer programming instructions, also referred to a computer executable instructions or processor executable instruction. Such instruction can be loaded from and stored in one or more memory devices collectively referred to as storage 123. Storage 123 may include electrically erasable programmable read-only memory (EEPROM) such as Flash memory (e.g., NAND and NOR flash memory or other types of solid-state memory), dynamic random-access memory (DRAM), static RAM (SRAM), magnetic disk storage, and the like. The storage 123 may be integrated with the controller 122 or provided as a separate memory device coupled to the controller 122.

The marine propulsion system 102 also includes an inverter 129 that that is powered by the high voltage batteries 103. The inverter 129 functions to convert the DC current received from the high voltage batteries 103 to alternating current (AC) that can be used by an electric motor. In some examples, the inverter 129 is a high voltage two-phase DC to a high voltage three-phase AC converter. The marine propulsion system also includes an electric motor 124 coupled to a propeller/impeller 125. The electric motor 124 is powered by the current received from the inverter 129. The electric motor 124 is an electric traction motor that turns a drive shaft (not shown) that drives the propeller/impeller 125. In some examples, the electric motor is a permanent magnet electric motor. The electric motor 124 is designed to withstand exposure to water and corrosive marine environments, featuring waterproof enclosures, sealed bearings, and corrosion-resistant materials to ensure reliable operation in wet conditions. The electric motor 124 operates quietly, producing minimal noise and vibration compared to traditional combustion engines, which contributes to a quieter boating experience as well as reduced noise pollution in aquatic environments. The electric motor 124 offers high efficiency and energy density, allowing electric boats to achieve comparable performance to traditional boats powered by combustion engines while using less energy and producing fewer emissions.

A control program 127 embodied in computer programing instructions is stored within tangible persistent storage of storage 123. When executed by the controller 122, the control program 127 is configured to receive commands from the vessel control unit 108 and control the electric motor 124 in accordance with those commands. For example, the control program 127 may be configured to regulate the distribution of electrical energy from the inverter 129 to the electric motor 124. In this example, the control program 127 may receive a throttle/speed command from the vessel control unit 108 and determine the frequency variation or voltage variation that will enter the electric motor 124 for controlling the vessel's speed. The control program 127 is further configured to receive motor state information from various sensors (not shown) and supply motor state information and diagnostic information to the vessel control unit 108. Also stored in tangible persistent storage of storage 123 is a security management module 126. Aspects of the security management module 126 will be described in greater detail below.

For further explanation, FIG. 1C sets forth a block diagram of an example of the high voltage battery 103 in accordance with at least one embodiment of the present disclosure. The example high voltage battery 103 of FIG. 1C includes a CAN interface 131 for coupling the high voltage battery 103 to the CAN bus 110. For example, the CAN interface 131 may be a network interface controller configured to send and receive messages in the form of CAN frames over the CAN bus 110. The example high voltage battery 103 includes array of battery cells 135 organized into battery modules 140 or battery packs, and a set of battery contactors 137 that selectively couple the battery modules 140 to high voltage terminals 138 of the battery 103.

The example high voltage battery 103 also includes a battery management system (BMS) 134 comprising a battery management controller 132 coupled to the CAN interface 131. Battery management controller 132 may include or implement a processor, a microcontroller, an ASIC, PLA such as an FPGA, or other data processing unit in accordance with the present disclosure. In some examples, battery management controller 132 is implemented by a processor or central processing unit configured to execute computer programming instructions, also referred to a computer executable instructions or processor executable instruction. Such instructions can be loaded from and stored in one or more memory devices collectively referred to as storage 133. Storage 133 may include EEPROM such as Flash memory (e.g., NAND and NOR flash memory or other types of solid-state memory), DRAM, SRAM, magnetic disk storage, and the like. The battery management system 134 further includes a variety of sensors (not shown) coupled to battery cells for measuring battery state information. The storage 133 may be integrated with the battery management controller 132 or provided as a separate memory device coupled to the battery management controller 132.

The BMS 134 includes a control program 139 embodied in computer programing instructions stored in tangible persistent storage of storage 133. In some examples, the control program 139 controls the state of the battery contactors for selectively coupling and decoupling the battery modules 140 to the high voltage terminals 138 of the battery 103. In some examples, the control program 139 also monitors battery state information such as voltage, current, and temperature in battery cells 135 via the above-mentioned sensors. In some examples, the control program 139 also communicates with the vessel control unit 108 to provide battery state information. The control program also controls the charging of the battery cells 135. BMS 134 further includes a security management module 136 stored in tangible persistent storage of storage 133. Aspects of the security management module 136 will be described in greater detail below.

For further explanation, FIG. 1D sets forth a block diagram of an example of the PDU 104 in accordance with at least one embodiment of the present disclosure. The example PDU 104 of FIG. 1D includes a CAN interface 141 for coupling the PDU 104 to the CAN bus 110. For example, the CAN interface 141 may be a network interface controller configured to send and receive messages in the form of CAN frames over the CAN bus 110. The PDU 104 also includes a battery interface 144 coupling the high voltage batteries 103 to a switching system 145 of the PDU 104, a charge port interface 150 coupling the charging port 105 to the switching system 145, a motor interface 147 coupling the marine propulsion system 102 to the switching system 145, and a DCDC interface 148 coupling the DCDC converter 106 to the switching system 145. The switching system 145 includes a set of contactors (not shown for simplicity) by which the PDU 104 supplies power from the high voltage batteries 103 to the marine propulsion system 102 and to the DCDC converter 106, or supplies power from the charging port 105 to the high voltage batteries 103.

The example PDU 104 also includes a controller 142 that may include or implement a processor, a microcontroller, an ASIC, PLA such as an FPGA, or other data processing unit in accordance with the present disclosure. In some examples, the controller 142 is implemented by a processor or central processing unit configured to execute computer programming instructions, also referred to a computer executable instructions or processor executable instruction. Such instructions can be loaded from and stored in one or more memory devices collectively referred to as storage 143. Storage 143 may include EEPROM such as Flash memory (e.g., NAND and NOR flash memory or other types of solid-state memory), DRAM, SRAM, magnetic disk storage, and the like. The storage 143 may be integrated with the controller 142 or provided as a separate memory device coupled to the controller 122.

The PDU 104 also includes a control program 149 embodied in computer programing instructions stored in tangible persistent storage of storage 143. When executed by the controller 142, the control program 149 is configured to receive commands from the vessel control unit 108 and control the switching system 145 to connect and disconnect power supplied to vessel components. The control program 149 is also configured to provide state information to vessel control unit 108. Also stored in tangible persistent storage is a security management module 146. Aspects of the security management module 146 will be described in more detail below.

For further explanation, FIG. 1E sets forth a block diagram of an example of vessel control unit 108 in accordance with at least one embodiment of the present disclosure. The example vessel control unit 108 of FIG. 1E includes a CAN interface 151 for coupling the vessel control unit 108 to the CAN bus 110. For example, the CAN interface 151 may be a network interface controller configured to send and receive messages in the form of CAN frames over the CAN bus 110.

The example vessel control unit 108 also includes a controller 152 that may include or implement a processor, a microcontroller, an ASIC, PLA such as an FPGA, or other data processing unit in accordance with the present disclosure. In some examples, controller 152 is implemented by a processor or central processing unit configured to execute computer programming instructions, also referred to a computer executable instructions or processor executable instruction. Such instructions can be loaded from and stored in one or more memory devices collectively referred to as storage 153. Storage 153 may include EEPROM such as Flash memory (e.g., NAND and NOR flash memory or other types of solid-state memory), DRAM, SRAM, magnetic disk storage, and the like. The storage 153 may be integrated with the controller 152 or provided as a separate memory device coupled to the controller 152.

The vessel control unit 108 also includes a control program 154 embodied in computer programing instructions stored in tangible persistent storage of storage 153. When executed by controller 152, the control program 154 is configured to send commands to other vessel components and receive state information and diagnostic data from vessel components as discussed above. Also stored in tangible persistent storage is a security management module 126. Aspects of the security management module 126 will be described in greater detail below.

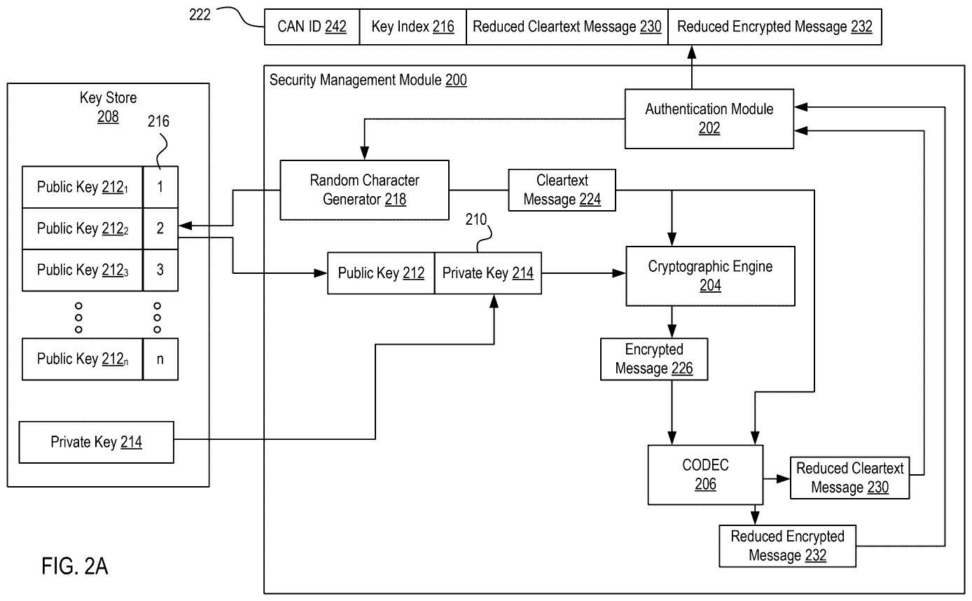

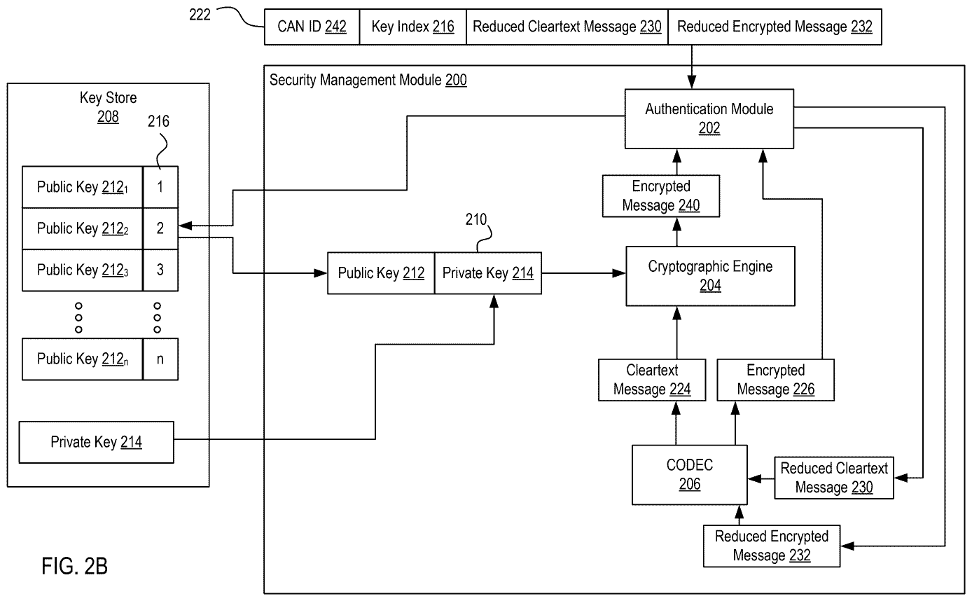

FIG. 2A sets forth an example security management module 200 for authenticating powertrain components of an electric vessel by a battery management controller in accordance with at least one embodiment of the present disclosure. The security management module 200 may be, for example, the any of the security management modules discussed above with reference to FIGS. 1B-1E. In some examples, the security management module 200 is embodied in a set of computer programing instructions that are stored in a memory (e.g., the storage of FIGS. 1B-1E) that, when executed by a processor, cause the processor to implement the operations described below. In other examples, the security management module 200 may be implemented in digital logic, such as an application specific integrated circuit or programmable logic device.

The security management module 200 of a particular vessel component expects to receive an authentication message from one or more other vessel components. If an expected authentication message is not received, the security management module 200 signals a security error. For example, the list of vessel components for which the authentication message is expected may be stored in a memory device. The list may be a list of CAN identifiers corresponding to the vessel components for which the authentication message is expected. The security management module expects the authentication message at startup or system initialization. Thereafter, the security management module 200 may expect the authentication message based on an authentication schedule, which may be based on a timer. For example, if the security management module 200 does not receive the authentication message by the end of a timeout period since the last authentication message, the security management module 200 may signal a security error. The security management module 200 also authenticates each vessel component for which an authentication message is expected. The authentication of a vessel component is described in more detail below. If authentication of a vessel component fails, the security management module 200 may signal a security error. In response to detecting the security error, the vessel may be disabled. The mechanism for disabling the vessel may depend upon the vessel component that detects the security error, as described below.

In the example of FIG. 2A, the security management module 200 includes a cryptographic engine 204 configured to encrypt and decrypt data. For example, the cryptographic engine 204 can implement the AES128 encryption algorithm to encrypt and decrypt data. It will be appreciated by those of skill in the art that AES128 is discussed as an illustrative example and that a cryptographic engine 204 in accordance with the present disclosure can be implemented using other encryption algorithms and key lengths. For encryption and decryption, the cryptographic engine 204 uses an encryption key 210 stored in a key store 208. The key store 208 is replicated on each genuine component of the vessel. In some examples, an encryption key 210 is produced by concatenating a public key 212 and a private key 214. For example, the public key 212 and the private key 214 are each 64-bit keys. In some implementations, the key store 208 includes multiple public keys 212₁₋ₙ that are each associated with a key index 216. To produce an encryption key 210, the cryptographic engine 204 selects one of the public keys 212₁₋ₙ based on the key index 216 (e.g., generated at random or provided in an authentication message, as discussed below), and concatenates the selected public key with the private key to produce a 128-bit encryption key. In some examples, the key store 208 is implemented by a data structure stored a memory device, such as any of the memory devices previously discussed. In some implementations, the private key 214 is stored separately in a secure storage device (not shown). In some examples, the private key 214 is encoded in all genuine components that are produced for the vessel. Thus, the private key 214 is pre-shared among the vessel components. The cryptographic engine 204 encrypts and decrypts messages using the encryption key 210. For example, a 128-bit encryption key is used to encrypt or decrypt a 128-bit message; however, these key lengths and message lengths are provided for illustrative purposes only. It will be appreciated that other key lengths, message lengths, and encryption algorithms may be employed. Additional explanations regarding encryption keys for encryption and decryption by the cryptographic engine 204 is provided below.

In the example of FIG. 2A, the security management module 200 also includes an encoder/decoder (‘codec’) 206 configured to encode and decode data in accordance with a particular scrambling protocol. For example, to scramble message data, codec 206 selects a subset of bytes of the message, where the byte positions in the data are preconfigured. In one example where 16 bytes of message data are input to the codec 206, the code 206 selects byte 0, byte 7, byte 8, and byte 15 of the data to reduce the 16-byte message to a 4-byte message. To descramble data, codec 206 receives a subset of bytes of a message and reconstructs the message data from the subset of bytes using a descrambling mechanism. For example, knowing a priori the byte positions of the subset of bytes within the message to be decoded, the descrambling mechanism applies a particular order of XOR, SUM, and SHIFT operations to generate the missing bytes and reconstruct the original message data. In one example, codec 206 receives 4 bytes of message data. Knowing that the 4 bytes correspond to byte 0, byte 7, byte 8, and byte 15 and of the original message data, codec 206 applies the XOR, SUM, and SHIFT operations of the descrambling mechanism to generate the missing bytes of the 16-byte message data.

In the example of FIG. 2A, the security management module 200 also includes a random character generator 218. In some examples, the random character generator 218 generates a random number, or random text that is hashed to create a random number, which can be used as a key index 216 to select a public key 212. In some examples, the random character generator 218 can be used to generate cleartext for an authentication message, which is described in more detail below.

In the example of FIG. 2A, the security management module 200 also includes an authentication module 202 configured to generate authentication messages and authenticate vessel components based on received authentication messages. The operation of the security management module 200 to generate an authentication message 222 is now described. In response to a particular trigger (e.g., a timer or the receipt of an authentication message from another vessel component), the authentication module 202 initiates the generation of the authentication message 222 by requesting a random number from the random character generator 218. The authentication module 202 uses the random number as the key index 216 (e.g., ‘2’) to select a public key 212 (e.g., public key 212₂) from the key store 208. However, in alternative examples, a timer synchronized to the reception of the last CAN frame can be used to generate a random number. The public key 212 is concatenated with the private key 214 to produce the encryption key 210, which is supplied to the cryptographic engine 204.

The authentication module 202 also requests randomly generated text for a cleartext message 224 (e.g., 16 bytes of clear text) from the random character generator 218. The cleartext message 224 is supplied to the cryptographic engine 204 and to codec 206. The cryptographic engine 204 encrypts the cleartext message 224 using the encryption key 210 to generate an encrypted message 226 (e.g., 16 bytes), which is provided to codec 206. Codec 206 encodes the cleartext message 224 and the encrypted message 226 by reducing the message based on selected byte positions, as discussed above. For example, codec 206 selects byte 0, byte 7, byte 8, and byte 15 of the clear text message 224 to generate a reduced cleartext message 230 (4 bytes) and selects byte 0, byte 7, byte 8, and byte 15 of the encrypted message 226 to generate a reduced encrypted text message 232 (4 bytes). It will be appreciated that the number of bytes and byte positions used to reduce a message are provided for illustrative purposes only.

The authentication module 202 generates the authentication message 222 by constructing a CAN frame that includes the key index 216, the reduced cleartext message 230, and the reduced encrypted message 232. The authentication message 222 is then transmitted over the CAN bus. In some examples, the authentication message 222 also includes an identifier, such as a CAN identifier, of the vessel component transmitting the authentication message 222.

For further explanation, FIG. 2B illustrates the operation of the security management module 200 to authenticate another vessel component based on an authentication message 222 received from that vessel component. In some examples, the authentication message includes the CAN identifier 242 of the vessel component, a key index 216, the reduced cleartext message 230, and the reduced encrypted message 232. The reduced cleartext message 230 is provided to the codec 206, which reconstructs the cleartext message 224 from the reduced cleartext message 230 based on the known mapping between the bytes of the reduced cleartext message 230 and their byte positions within the clear text message 224, and further by application of the descrambling mechanism to supply the missing bytes. Likewise, the reduced encrypted message 232 is provided to the codec 206, which reconstructs the encrypted message 226 from the reduced encrypted message 232 based on the known mapping between the bytes of the reduced encrypted message 232 and their byte positions within the encrypted message 226, and further by application of the descrambling mechanism to supply the missing bytes.

The key index 216 provided in the authentication message 222 is used to identify a public key 212 from the key store 208. The authentication module 202 concatenates the corresponding public key 212 with the private key 214 to produce the encryption key 210, which is supplied to the cryptographic engine 204. The cleartext message 224 is also supplied to the cryptographic engine 204, which encrypts the cleartext message 224 to generate another encrypted message 240. The authentication module 202 then compares the received encrypted message 226 to the generated encrypted message 240 to determine whether they are identical. If the encrypted message 226 and the encrypted message 240 are identical, the vessel component associated with the CAN identifier 242 in the authentication message 222 is authenticated, in that the security management module 200 determines that the vessel component is a genuine component. If the encrypted message 226 and the encrypted message 240 are not identical, the security management module 200 may signal to a vessel component controller that one or more vessel components have failed authentication, which allows the vessel component controller to perform an error handling action.

Although the authentication protocol described above includes comparing the received encrypted message 226 to the encrypted message 240 generated by encrypting the cleartext message 224, in alternative implementations the authentication module 202 can decrypt the encrypted message 226 to generate cleartext, and compare that cleartext to the cleartext message 224.

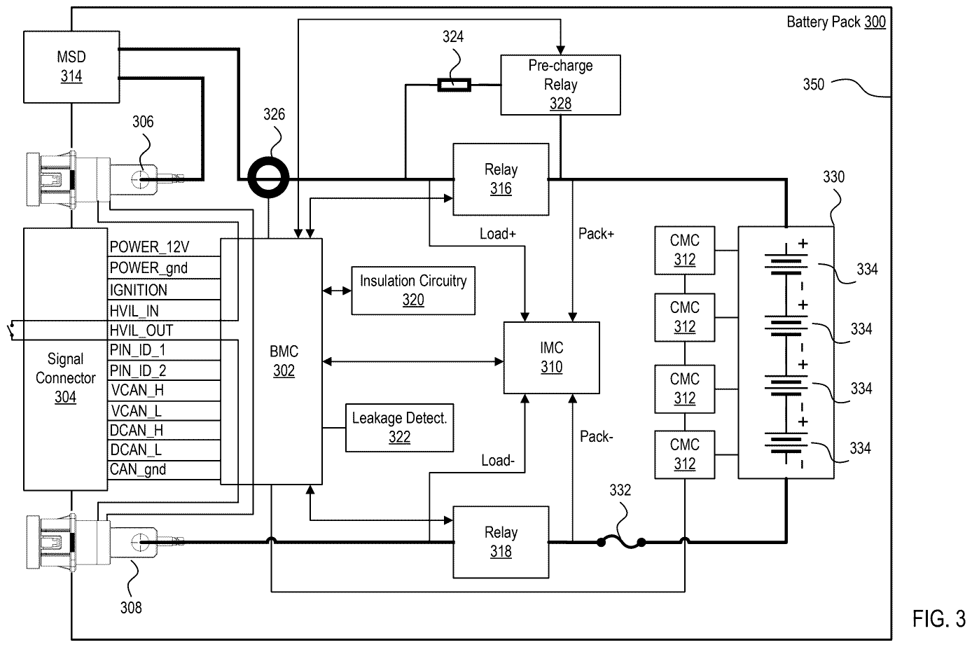

FIG. 3 sets forth a schematic of an example high voltage (HV) battery pack 300 for an electric marine vessel in accordance with the present disclosure. The battery pack 300 is enclosed in a chassis 350. Particular external interfaces of the battery pack 300 include a signal connector 304, an HV+ plug 306, and HV− plug 308, and a manual service disconnect (MSD) connector 314 used for breaking the electrical continuity within the battery pack 300 in the event of a fault. The HV+ plug 306 is couplable to a PDU, such as the PDU 104 described above. Within the battery pack 300, the HV+ plug is electrically coupled to a relay 316 via MSD connector 314. A disconnect of the MSD connector 314 causes a break in the connection of the HV+ plug 306 to the relay 316, thus providing a disconnect of the battery pack 300 to the PDU for safe servicing of the vessel. The relay 316 is coupled to a positive terminal of a battery device 330 that includes multiple battery cells 334. In an example, the battery cells 334 are connected in series between positive and negative terminals of the battery device 330. It will be appreciated that the battery device 330 may also include multiple parallel strings of battery cells 334. Although four battery cells 334 are shown for illustration, it will be appreciated that any number of battery cells may be employed. Like the HV+ plug 306, the HV− plug 308 is couplable to the PDU. Within the battery pack 300, the HV− plug 308 is electrically coupled to a relay 318, which is in turn electrically coupled to the negative terminal of the battery device 330 through a fuse 332. The fuse 332 provides overcurrent protection in the event of a fault in the battery device 330. Accordingly, activation of the relays 316, 318 closes a circuit between the HV+ plug 306 and the HV− plug 308 through the battery device 330 for providing HV power to the PDU. In some examples, the relays 316, 318 and/or the fuse 332 are embedded with a voltage leak detector.

The battery pack 300 also includes a battery management controller (BMC) 302 for a battery management system, such as the battery management system 134 discussed above. The BMC 302 can be implemented as an ASIC, a microcontroller, a programmable logic device, a processor executing instructions stored in a memory device, or other circuitry configurable to implement the functionality of the BMC 302 described herein. The BMC 302 is communicatively coupled to the relay 316 through one or more interconnects for providing commands to the relay 316 and receiving state information from the relay 316. A command from the BMC 302 to the relay 316 opens or closes the relay in accordance with the command. In some examples, the relay 316 also includes an auxiliary contactor, with auxiliary input and auxiliary output signals coupled to the BMC 302. The BMC 302 is also communicatively coupled to the relay 318 through one or more interconnects for providing commands to the relay 318 and receiving state information from the relay 318. A command from the BMC 302 to the relay 318 opens or closes the relay in accordance with the command. In some examples, the relay 318 also includes an auxiliary contactor, with auxiliary input and auxiliary output signals coupled to the BMC 302.

The battery pack 300 also includes a pre-charge relay 328 and pre-charge resistor 324 for pre-charging the inverter of the marine propulsion system before the HV connection is established between the battery pack 300 and the inverter. A command from the BMC 302 to the pre-charge relay 328 opens or closes the relay in accordance with the command. In some examples, the pre-charge circuit in the battery manages a 1 mF capacitor at the input of the inverter 129. Each time the battery pack 300 transitions from an IDLE to an ACTIVE state, a pre-charge sequence is completed by the BMC 302 before enabling the HV+ relay. If the BMC 302 detects an abnormal consumption during pre-charge, the BMC 302 transitions to a FAILURE state and opens the contactors.

The battery pack 300 also includes an isolated measurement controller (IMC) 310 that is electrically coupled to the HV+ line between the relay 316 and the battery device 330 to measure a positive voltage (Pack+) supplied by the battery device 330. The IMC 310 is also electrically coupled to the HV+ line on the output side of the relay 316 to measure a positive load (Load+) on the battery pack 300. The IMC 310 is electrically coupled to the HV-line between the relay 318 and the battery device 330 to measure a negative voltage (Pack−) supplied by the battery device 330. The IMC 310 is also electrically coupled to the HV−line on the output side of the relay 318 to measure a negative load (Load−) on the battery pack 300. The IMC 310 provides the measurements for Pack+, Load+, Pack−, and Load− to the BMC 302. Thus, the IMC 310 isolates the BMC 302 from the HV lines. The battery pack 300 also includes a current sensor 326 coupled to at least one of the HV lines for measuring load current.

The battery pack 300 also includes insulation circuitry 320. In some examples, the insulation circuitry 320 includes an insulation barrier that provides insulation for digital, pulse width modulated, and 12V power supply. The insulation barrier may be coupled to an insulation board. For example, the insulation board may be coupled to the HV+ and HV-by respective relays that are controlled by the BMC 302. The insulation board may be coupled to ground via connection to the chassis 350.

The battery pack 300 also includes cell measurement controllers (CMC) 312. Each battery cell 334 is coupled to a respective CMC 312. The CMC 312 reads measurements of the battery cell 334 such as the voltage and temperature of the battery cell 334. The CMC 312 provides these measurements to the BMC 302.

The battery pack 300 also includes a leakage detector 322 that detects whether there is a coolant leak or the presence of water in the battery pack 300. The leakage detector 322 wakes up as soon as an IGNITION signal turns ON (e.g., transitions from low to high) to control any leakage present inside the battery and before closing the contactors. In the ACTIVE state (relays closed), the BMC 302 can receive a command to start the leakage detector at any moment to control the HV line in the vessel.

The BMC 302 monitors the condition of the battery pack 300 based on measurements including voltage and temperature measurements of the battery cells 334 from the CMCs 312, voltage measurements of the battery output and the load on the battery pack 300 from the IMC 310, signals from the leakage detector 322, and current measurements from the current sensor 326 to determine whether the battery pack 300 should be placed in a FAILURE state. For example, the BMC 302 can detect a thermal runaway event, a battery short, an overcurrent condition, an overvoltage condition, an undervoltage condition, and so on based on these measurements. When these measurements do not indicate a FAILURE state, the BMC 302 will control the opening and closing of the relays 316, 318 in accordance with signals from the VCU 108 and/or the PDU 104. In response to an IGNITION signal going high, the BMC 302 will wake up and place the battery pack 300 in an ACTIVE state, execute the pre-charge sequence to pre-charge the inverter of the marine propulsion system, and then close the relays 316, 318 to provide HV power to the inverter. In response to the IGNITION signal going low, the BMC 302 will open the relays 316, 318 and place the battery pack 300 in an IDLE state. In a FAILURE state, the relays 316, 318 are always open.

The signal connector 304 is coupled to the BMC 302 to provide external signals to the BMC 302. In a particular implementation as shown in FIG. 3, the signal connector 304 provides a wake-up signal (IGNITION) to the BMC 302. The IGNITION signal provides 12V supply for the HVIL and for BMC 302 wake-up. The signal connector 304 also provides a 12V power signal (POWER_12V) to the BMC 302. The 12V power signal provides a power supply for the BMC 302, relays, insulation board, and other low voltage components. In these examples, the signal connector 304 also provides a ground (POWER_gnd) to the BMC 302. POWER_gnd provides a ground reference for the POWER and IGNITION supply. The signal connector 304 provides HVIL loop signals (HVIL_IN and HVIL_OUT) from the PDU 104 to the BMC 302. HVIL_IN is the input of the ignition 12V passed through the battery pack HVIL and PDU HVIL. HVIL_OUT is the output of the ignition 12V passed through the battery pack HVIL and going to the PDU HVIL before returning via HVIL_IN. Within the battery pack HVIL, an HVIL signal passes from HVIL_IN of the signal connector 304 through the BMC 302 to an HVIL input of the HV+ plug 306, from an HV output of the HV+ 306 through the BMC 302 to an HVIL input of the HV− plug 308, and from an HVIL output of the HV− plug 308 through the BMC 302 to HVIL_OUT of the signal connector 304. Thus, the BMC 302 can detect a break in the HVIL circuit within the battery pack 300 caused by a disconnect of the HV+ plug 306 or the HV− plug 308 (it will be appreciated that the positions of the HV plugs within the circuit can be reversed).

The signal connector 304 also provides identification numbers for the battery pack 300 to the BMC 302, where PIN_ID1 is the least significant bit of the battery pack 300 identifier and PIN_ID2 is the most significant bit of the battery pack 300 identifier. The signal connector 304 provides CAN bus signals (VCAN_H and VCAN_L) to the BMC 302. VCAN_H is the CAN high of the vessel-side CAN bus and is used for communication with the VCU 108. VCAN_L is the CAN low of the vessel-side CAN bus and is used for communication with the VCU 108. The signal connector 304 provides diagnostic CAN bus signals (DCAN_H and DCAN_L) to the BMC 302 and is used for diagnostics only. DCAN_H is the CAN high of the internal battery pack CAN bus. DCAN_L is the CAN low of the internal battery pack CAN bus. In some examples, the signal connector 304 provides a ground for the CAN bus to the BMC 302. CAN_gnd provides the ground reference for the vessel side CAN bus (VCAN_H and VCAN_L) and is the same electric potential as POWER_gnd. It will be appreciated that embodiments of the present disclosure may be realized without inclusion of all of the signals described above. It will also be appreciated that the signals connector 304 may provide additional signals not described above.

In a particular implementation, the BMC 302 wakes up when IGNITION is high and if POWER is high. The HVIL can be powered by the POWER or the IGNITION signal. CAN bus communication is only enabled when IGNITION is high. PIN_ID1 and PIN_ID2 are 0 at low and 1 at high. In a particular implementation, only ‘00’, ‘01’ and ‘10’ are allowed as identifiers, where ‘11’ (open connection) is detected as an error. The battery pack 300 need not manage any conflict if multiple batteries are set with the same ID. The VCU 108 manages the CAN bus period integrity.

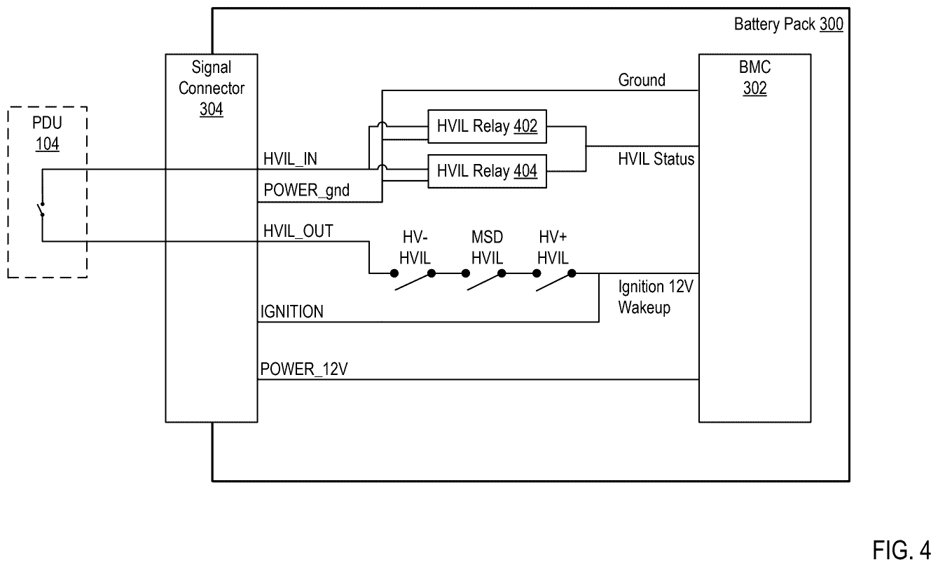

For further explanation, FIG. 4 sets forth a schematic of an example internal HVIL circuit for the battery pack 300 in accordance with at least one embodiment of the present disclosure. The example of FIG. 4 includes the signal connector 304 and the BMC 302 of FIG. 3. A loop of the HVIL system extends from the battery pack to the PDU and back to the battery pack such that a disconnection of the PDU and the battery pack will break the loop and trigger a FAILURE state. As shown in FIG. 4. HVIL_OUT is the IGNITION signal that is routed through HVIL_OUT to the PDU 104 and back into HVIL_IN, which is routed though the internal battery pack HVIL circuit that includes the HV+ HVIL connections and the HV-HVIL connections, and then back to HVIL_OUT. When any of the HV+ HVIL signal, the HV-HVIL signal, and the MSD signal are interrupted due to disconnect, the BMC 302 will detect the break in the loop and trigger a FAILURE state. In this case, HVIL_OUT of the battery pack is also interrupted. HVIL_IN and POWER_gnd are routed to first HVIL relay 402 and a second HVIL relay 404. When both HVIL relays 402, 404 are closed, the HVIL status input to the BMC 302 indicates that there is no failure in the HVIL system. When at least one HVIL relay 402, 404 is open, the HVIL status input to the BMC 302 indicates a failure state.

The relays 402, 404 open as soon as the HV+ or HV-cables are disconnected. The PDU 104 is equipped with such relays in order to automatically cut off the power supply power contacts. A fault detector in the battery pack 300 will detect 12V when the four HVIL switches are closed (two from the battery plugs and two from the PDU connectors). Thus, if the battery pack 300 is disconnected, the relays 316, 318 open and the battery state is placed in a FAILURE state. The FAILURE state has to be acknowledged and the HVIL error fixed before the BMC 302 transitions the battery pack 300 back to an IDLE state. The battery contactors are closed only in an ACTIVE state, after receiving a valid CAN request from the VCU 108.

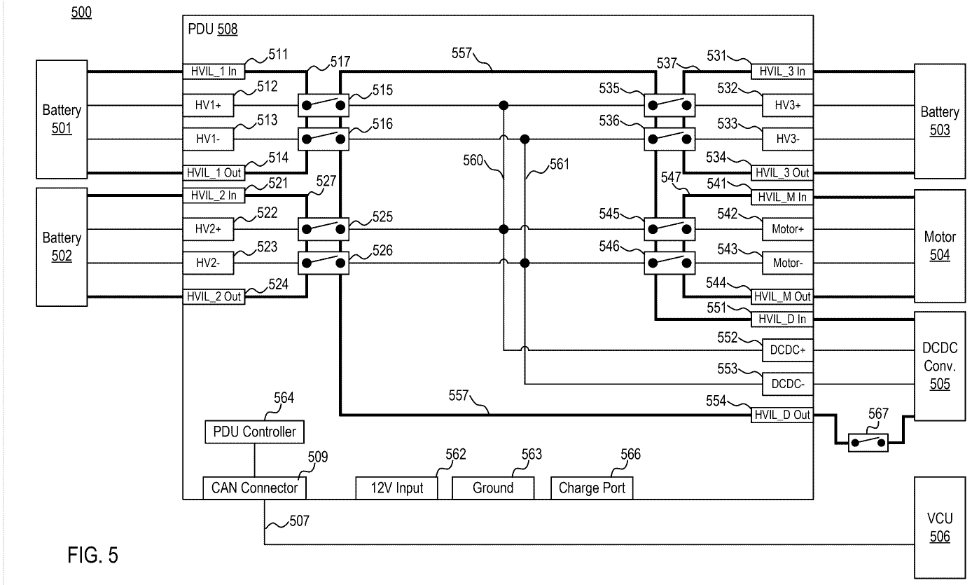

FIG. 5 sets forth a block diagram of an example powertrain system 500 for enhancing safety in an electric marine vessel using independent fault detection loops in a power distribution unit in accordance with at least one embodiment of the present disclosure. For example, the powertrain system 500 can be used to implement the powertrain of vessel 100. System 500 includes high voltage batteries 501, 502, 503. Although three high voltage batteries are shown, it will be appreciated that system 500 can include more or fewer high voltage batteries. High voltage batteries 501, 502, 503 may correspond to high voltage batteries 103 in FIGS. 1A and 1C and/or battery pack 300 of FIGS. 3 and 4. System 500 also includes at least one motor 504 that provides propulsion for a marine vessel. For example, motor 504 may correspond to marine propulsion system 102 of FIGS. 1A and 1B. Motor 504 can be an outboard motor or similar marine propulsion device. Motor 504 is an electric motor in that motor 504 does not include an internal combustion engine. Motor 504 is operable using power provided by high voltage batteries 501, 502, 503. Although only one motor 504 is depicted, it will be appreciated that system 500 may include additional electric propulsion motors.

System 500 also includes DCDC converter 505 for converting high voltage power

supplied by high voltage batteries 501, 502, 503 to a lower voltage. For example, DCDC converter 505 may be used to step down the high voltage of high voltage batteries 501, 502, 503, which may be on the order of 500-800V, to a 12V supply that can be used to charge a 12V marine battery and/or supply power to auxiliary systems such as lights, pumps, etc. DCDC converter 505 may correspond to DCDC converter 106 of FIG. 1A. System 500 also includes VCU 506 that communicates with powertrain components via a CAN bus 507. VCU 506 may correspond to VCU 108 in FIGS. 1A and 1E.

System 500 also includes PDU 508 that may be used to implement PDU 104 of FIGS. 1A and 1D. PDU 508 provides a high-voltage input interfaces configured to receive power from the vessel's energy storage systems and charging devices, as well as output channels for propulsion systems, and auxiliary systems and onboard devices. PDU 508 provides a control module with communication interfaces (e.g., the CAN bus) for real-time monitoring, fault detection, and remote diagnostics. PDU 508 provides a weatherproof and corrosion-resistant housing optimized for marine environments, as well as tamper detection and safety circuitry that is triggered by opening the PDU housing. As will be evident from the detailed description of PDU 508 below, PDU 508 enhances energy efficiency, improves system reliability, and ensures safety in electric boat operations.

In the example of FIG. 5, PDU 508 is coupled to high voltage batteries 501, 502, 503, motor 504, DCDC converter 505, and VCU 506. With respect to battery 501, PDU 508 includes an HV1+ connector 512 for coupling to a positive high voltage connector of battery 501 and a HV1− connector 513 for coupling to a negative high voltage connector of battery 501. HV1+ connector 512 supplies the positive high voltage of battery 501 to HV1+ contactor 515 and HV1− connector 513 supplies the negative high voltage of battery 501 to HV1− contactor 516. HV1+ contactor 515 may be a relay or other electromechanical switching device that opens and closes a circuit connecting the positive high voltage supply of battery 501 to a positive high voltage power bus 560 within PDU 508. In some examples, HV1+ contactor 515 opens and closes in response to commands received from PDU controller 564, as described in more detail below. HV1+ contactor 515 may be powered by a 12V power supply that is used to actuate switching components (e.g., a solenoid actuator mechanism) within the contactor. HV1− contactor 516 may be a relay or other electromechanical switching device that opens and closes a circuit connecting the negative high voltage supply of battery 501 to a negative high voltage power bus 561 within PDU 508. In some examples, HV1− contactor 516 opens and closes in response to commands received from PDU controller 564, as described in more detail below. HV1− contactor 516 may be powered by a 12V power supply that is used to actuate switching components (e.g., a solenoid actuator mechanism) within the contactor.

With respect to battery 501, PDU 508 also includes HVIL_1 input connector 511 and HVIL_1 output connector 514 that are used to implement an fault detection circuit in connection with battery 501, namely HVIL_1 loop 517. In some examples, HVIL loop 517 may be implemented as a 12V signal that is received from and HVIL output battery 501 and fed back to an HVIL input of battery 501. As such, HVIL_1 input connector 511 and HVIL_1 output connector 514 are used to detect an interruption in HVIL_1 loop 517, which may be triggered by an opening of an HVIL contactor in battery 501 as previously explained in relation to FIGS. 3 and 4. In some examples, HVIL_1 loop 517 runs through HV 1+connector 512 and HV1− connector 513, such that an HVIL contactor in HV1+ connector 512 or HV1− connector 513 is opened upon detection of a disconnection of a cable from HV1+ connector 512 or HV1− connector 513, respectively, as will be explained in more detail below. As such, HVIL_1 loop 517 is interrupted by a HVIL fault in battery 501 or an HVIL fault in PDU 508 (e.g., a disconnection of a battery cable from PDU 508).

In some examples, HV1+ contactor 515 and HV1− contactor 516 are actuated by HVIL_1 loop 517. For example, HV1+ contactor 515 automatically opens in response to an interruption in HVIL_1 loop 517. Similarly, HV1− contactor 516 automatically opens in response to an interruption in HVIL_1 loop 517. Thus, when a battery cable is disconnected from HVIL_1 input connector 511 or HVIL_1 output connector 514, HV1+ contactor 515 and HV1− contactor 516 automatically open. When HVIL_1 loop 517 is interrupted at battery 501, HV1+ contactor 515 and HV1− contactor 516 automatically open. Thus, HVIL_1 loop 517 ensures safety in handling the PDU 508 after disconnection with battery 501.

In some examples, HV1+ contactor 515 and HV1− contactor 516 are actuated by HVIL_D loop 557, which is a fault detection circuit implemented in connection with DCDC converter 505, as explained in more detail below. For example, HV1+ contactor 515 automatically opens in response to an interruption in HVIL_D loop 557. Similarly, HV1− contactor 516 automatically opens in response to an interruption in HVIL_D loop 557. Thus, when a cable is disconnected from a DCDC connector, HV1+ contactor 515 and HV1− contactor 516 automatically open. When HVIL_D loop 557 is interrupted at DCDC converter 505, HV1+ contactor 515 and HV1− contactor 516 automatically open.

With respect to battery 502, PDU 508 includes an HV2+ connector 522 for coupling to a positive high voltage connector of battery 502 and a HV2− connector 523 for coupling to a negative high voltage connector of battery 502. HV2+ connector 522 supplies the positive high voltage of battery 502 to HV2+ contactor 525 and HV2− connector 523 supplies the negative high voltage of battery 502 to HV2− contactor 526. HV2+ contactor 525 may be a relay or other electromechanical switching device that opens and closes a circuit connecting the positive high voltage supply of battery 502 to a positive high voltage power bus 560 within PDU 508. In some examples, HV2+ contactor 525 opens and closes in response to commands received from PDU controller 564, as described in more detail below. HV2+ contactor 525 may be powered by a 12V power supply that is used to actuate switching components (e.g., a solenoid actuator mechanism) within the contactor. HV2− contactor 526 may be a relay or other electromechanical switching device that opens and closes a circuit connecting the negative high voltage supply of battery 502 to a negative high voltage power bus 561 within PDU 508. In some examples, HV2− contactor 526 opens and closes in response to commands received from PDU controller 564, as described in more detail below. HV 2-contactor 526 may be powered by a 12V power supply that is used to actuate switching components (e.g., a solenoid actuator mechanism) within the contactor.

With respect to battery 502, PDU 508 also includes HVIL_2 input connector 521 and HVIL_2 output connector 524 that are used to implement an fault detection circuit in connection with battery 502, namely HVIL_2 loop 527. In some examples, HVIL loop 527 may be implemented as a 12V signal that is received from and HVIL output battery 502 and fed back to an HVIL input of battery 502. As such, HVIL_2 input connector 521 and HVIL_2 output connector 524 are used to detect an interruption in HVIL_2 loop 527, which may be triggered by an opening of an HVIL contactor in battery 502 as previously explained in relation to FIGS. 3 and 4. In some examples, HVIL_2 loop 527 runs through HV2+ connector 522 and HV2− connector 523, such that an HVIL contactor in HV2+ connector 522 or HV2− connector 523 is opened upon detection of a disconnection of a cable from HV2+ connector 522 or HV2− connector 523, respectively, as will be explained in more detail below. As such, HVIL_2 loop 527 is interrupted by a HVIL fault in battery 502 or an HVIL fault in PDU 508 (e.g., a disconnection of a battery cable from PDU 508).

In some examples, HV2+ contactor 525 and HV2− contactor 526 are actuated by HVIL_2 loop 527. For example, HV1+ contactor 525 automatically opens in response to an interruption in HVIL_2 loop 527. Similarly, HV2− contactor 526 automatically opens in response to an interruption in HVIL_2 loop 527. Thus, when a battery cable is disconnected from HVIL_2 input connector 521 or HVIL_2 output connector 524, HV2+ contactor 525 and HV2− contactor 526 automatically open. When HVIL_2 loop 527 is interrupted at battery 502, HV2+ contactor 525 and HV2− contactor 526 automatically open. Thus, HVIL_2 loop 527 ensures safety in handling the PDU 508 after disconnection with battery 502.

In some examples, HV2+ contactor 525 and HV2− contactor 526 are actuated by HVIL_D loop 557, which is a fault detection circuit implemented in connection with DCDC converter 505, as explained in more detail below. For example, HV1+ contactor 525 automatically opens in response to an interruption in HVIL_D loop 557. Similarly, HV2− contactor 526 automatically opens in response to an interruption in HVIL_D loop 557. Thus, when a cable is disconnected from a DCDC connector, HV2+ contactor 525 and HV2− contactor 526 automatically open. When HVIL_D loop 557 is interrupted at DCDC converter 505, HV2+ contactor 525 and HV2− contactor 526 automatically open.

With respect to battery 503, PDU 508 includes an HV3+ connector 532 for coupling to a positive high voltage connector of battery 503 and a HV3− connector 533 for coupling to a negative high voltage connector of battery 503. HV3+ connector 532 supplies the positive high voltage of battery 503 to HV3+ contactor 535 and HV3− connector 533 supplies the negative high voltage of battery 503 to HV3− contactor 536. HV3+ contactor 535 may be a relay or other electromechanical switching device that opens and closes a circuit connecting the positive high voltage supply of battery 503 to a positive high voltage power bus 560 within PDU 508. In some examples, HV3+ contactor 535 opens and closes in response to commands received from PDU controller 564, as described in more detail below. HV3+ contactor 535 may be powered by a 12V power supply that is used to actuate switching components (e.g., a solenoid actuator mechanism) within the contactor. HV3− contactor 536 may be a relay or other electromechanical switching device that opens and closes a circuit connecting the negative high voltage supply of battery 503 to a negative high voltage power bus 561 within PDU 508. In some examples, HV3− contactor 536 opens and closes in response to commands received from PDU controller 564, as described in more detail below. HV3− contactor 536 may be powered by a 12V power supply that is used to actuate switching components (e.g., a solenoid actuator mechanism) within the contactor.

With respect to battery 503, PDU 508 also includes HVIL_3 input connector 531 and HVIL_3 output connector 534 that are used to implement a fault detection circuit in connection with battery 503, namely HVIL_3 loop 537. In some examples, HVIL loop 537 may be implemented as a 12V signal that is received from and HVIL output battery 503 and fed back to an HVIL input of battery 503. As such, HVIL_3 input connector 531 and HVIL_3 output connector 534 are used to detect an interruption in HVIL_3 loop 537, which may be triggered by an opening of an HVIL contactor in battery 503 as previously explained in relation to FIGS. 3 and 4. In some examples, HVIL_3 loop 537 runs through HV3+ connector 532 and HV3− connector 533, such that an HVIL contactor in HV3+ connector 532 or HV3− connector 533 is opened upon detection of a disconnection of a cable from HV3+ connector 532 or HV3− connector 533, respectively, as will be explained in more detail below. As such, HVIL_3 loop 537 is interrupted by a HVIL fault in battery 503 or an HVIL fault in PDU 508 (e.g., a disconnection of a battery cable from PDU 508).

In some examples, HV3+ contactor 535 and HV3− contactor 536 are actuated by HVIL_3 loop 537. For example, HV3+ contactor 535 automatically opens in response to an interruption in HVIL_3 loop 537. Similarly, HV3− contactor 536 automatically opens in response to an interruption in HVIL_3 loop 537. Thus, when a battery cable is disconnected from HVIL_3 input connector 531 or HVIL_3 output connector 534, HV3+ contactor 535 and HV3− contactor 536 automatically open. When HVIL_3 loop 537 is interrupted at battery 503, HV3+ contactor 535 and HV3− contactor 536 automatically open. Thus, HVIL_3 loop 537 ensures safety in handling the PDU 508 after disconnection with battery 503.

In some examples, HV3+ contactor 535 and HV3− contactor 536 are actuated by HVIL_D loop 557, which is a fault detection circuit implemented in connection with DCDC converter 505, as explained in more detail below. For example, HV1+ contactor 535 automatically opens in response to an interruption in HVIL_D loop 557. Similarly, HV3− contactor 536 automatically opens in response to an interruption in HVIL_D loop 557. Thus, when a cable is disconnected from a DCDC connector, HV3+ contactor 535 and HV3− contactor 536 automatically open. When HVIL_D loop 557 is interrupted at DCDC converter 505, HV3+ contactor 535 and HV3− contactor 536 automatically open.

With respect to motor 504, PDU 508 includes a motor+connector 542 for supplying power to a positive high voltage connector of motor 504 and a motor-connector 543 for supplying power to a negative high voltage connector of motor 504. Motor+connector 542 receives the positive high voltage of positive high voltage bus 560 via motor+ contactor 545 and motor-connector 543 receives the negative high voltage of negative high voltage bus 561 via motor− contactor 546. Motor+ contactor 545 may be a relay or other electromechanical switching device that opens and closes a circuit connecting the positive high voltage connectors of motor 504 to the positive high voltage power bus 560 within PDU 508. In some examples, motor+ contactor 545 opens and closes in response to commands received from PDU controller 564, as described in more detail below. Motor+ contactor 545 may be powered by a 12V power supply that is used to actuate switching components (e.g., a solenoid actuator mechanism) within the contactor. Motor− contactor 546 may be a relay or other electromechanical switching device that opens and closes a circuit connecting the negative high voltage connectors of motor 504 to a negative high voltage power bus 561 within PDU 508. In some examples, motor− contactor 546 opens and closes in response to commands received from PDU controller 564, as described in more detail below. Motor− contactor 546 may be powered by a 12V power supply that is used to actuate switching components (e.g., a solenoid actuator mechanism) within the contactor.

With respect to motor 504, PDU 508 also includes HVIL_M input connector 541 and HVIL_M output connector 544 that are used to implement a fault detection circuit in connection with motor 504, namely HVIL_M loop 547. In some examples, HVIL_M loop 547 may be implemented as a 12V signal that is received from an HVIL output of motor 504 and fed back to an HVIL input of motor 504. As such, HVIL_M input connector 541 and HVIL_M output connector 544 are used to detect an interruption in HVIL_M loop 547, which may be triggered by an opening of an HVIL contactor in motor 504. In some examples, HVIL_M loop 547 runs through motor+connector 542 and motor-connector 543, such that an HVIL contactor in motor+connector 542 or motor-connector 543 is opened upon detection of a disconnection of a cable from motor+connector 542 or motor-connector 543, respectively, as will be explained in more detail below. As such, HVIL_M loop 547 is interrupted by a HVIL fault in motor 504 or an HVIL fault in PDU 508 (e.g., a disconnection of a power cable from PDU 508).

In some examples, motor+ contactor 545 and motor− contactor 546 are actuated by HVIL_M loop 547. For example, motor+ contactor 545 automatically opens in response to an interruption in HVIL_M loop 547. Similarly, motor− contactor 546 automatically opens in response to an interruption in HVIL_M loop 547. Thus, when a power cable is disconnected from HVIL_M input connector 541 or HVIL_M output connector 544, motor+ contactor 545 and motor− contactor 546 automatically open. When HVIL_M loop 547 is interrupted at motor 504, motor+ contactor 545 and motor− contactor 546 automatically open. Thus, HVIL_M loop 547 ensures safety in handling the PDU 508 after disconnection with motor 504.

In some examples, motor+ contactor 545 and motor− contactor 546 are actuated by HVIL_D loop 557, which is a fault detection circuit implemented in connection with DCDC converter 505, as explained in more detail below. For example, HV1+ contactor 545 automatically opens in response to an interruption in HVIL_D loop 557. Similarly, motor− contactor 546 automatically opens in response to an interruption in HVIL_D loop 557. Thus, when a cable is disconnected from a DCDC connector, motor+ contactor 545 and motor− contactor 546 automatically open. When HVIL_D loop 557 is interrupted at DCDC converter 505, motor+ contactor 545 and motor− contactor 546 automatically open.

With respect to DCDC converter 505, PDU 508 includes a DCDC+connector 552 for supplying power to a positive high voltage connector of DCDC converter 505 and a DCDC-connector 553 for supplying power to a negative high voltage connector of DCDC converter 505. DCDC+ connector 552 receives the positive high voltage of positive high voltage bus 560 and DCDC− connector 553 receives the negative high voltage of negative high voltage bus 561. PDU 508 also includes HVIL_D input connector 541 and HVIL_D output connector 554 that are used to implement a fault detection circuit in connection with DCDC converter 505, namely HVIL_D loop 547. HVIL_D loop enters PDU 508 at HVIL_D input connector 551 and connects to all contactors 515, 516, 525, 526, 535, 536, 545, 546 in PDU 508 before exiting PDU 508 at HVIL_D output connector 554. In some examples, HVIL_D loop 557 may be implemented as a 12V signal that is received from an HVIL output of DCDC converter 505 and fed back to an HVIL input of DCDC converter 505. As such, HVIL_D input connector 551 and HVIL_D output connector 554 are used to detect an interruption in HVIL_D loop 557, which may be triggered by an opening of an HVIL contactor in DCDC converter 505. In some examples, HVIL_D loop 557 runs through DCDC+ connector 542 and DCDC− connector 553, such that an HVIL contactor in DCDC+ connector 542 or DCDC− connector 553 is opened upon detection of a disconnection of a cable from DCDC+ connector 542 or DCDC− connector 553, respectively, as will be explained in more detail below. As such, HVIL_D loop 557 is interrupted by a HVIL fault in DCDC converter 505 or an HVIL fault in PDU 508 (e.g., a disconnection of a power cable from PDU 508). As previously explained, and interruption of HVIL_D loop 557 causes the automatic opening of contactors 515, 516, 525, 526, 535, 536, 545, 546. In this way, when a cable connecting PDU 508 is disconnected from DCDC converter 505, the DCDC+ connector 552 and DCDC− connector 553 are no longer hot, and these terminals or a cable connected to these terminals can be handled without risk of human injury.

In some examples, HVIL_D loop 557 includes an emergency stop (‘e-stop’) relay 567. Opening of the e-stop relay 567 interrupts HVIL_D loop 557 which, as explained above, causes all contactors in PDU 508 to open. E-stop relay 567 may be triggered by an e-stop button that is available to the boater for emergency situations. Pressing the e-stop button triggers the e-stop relay 567 to open, thus automatically opening all contactors in PDU 508. In other variations, e-stop relay 567 may be triggered by additional or alterative safety mechanisms.

PDU 508 includes a 12V input connector 562 and ground connector 563 for supplying power and ground to various electronic and electromechanical components including a PDU controller 564. The 12V supply voltage is also used a control voltage for various relays and switches such as contactors 515, 516, 525, 526, 535, 536, 545, 546.

PDU 508 also includes a charge port connector 566 for connecting positive high voltage power bus 560 and negative high voltage power bus 561 to a charging device via a charging port such as charging port 105 in FIG. 1A. In this way, PDU 508 facilitates the charging of batteries 501, 502, 503.

PDU controller 565 implements logic for controlling the state of the various contactors based on commands from VCU 506, as well as for providing state and diagnostic information to VCU 506. PDU controller 565 can be implemented as an ASIC, a microcontroller, a programmable logic device, a processor executing instructions stored in a memory device, or other circuitry configurable to implement the functionality of the PDU controller 565 described herein. PDU controller 565 may receive power and ground from 12V power connector 562 and ground connector 563. PDU controller 565 is communicatively coupled to HV1+ contactor 515 and HV1− contactor 516 through one or more signal interconnects for providing commands to HV1+ contactor 515 and HV1− contactor 516 and receiving state information from HV1+ contactor 515 and HV1− contactor 516. A command from the PDU controller 565 to HV1+ contactor 515 and HV1− contactor 516 opens or closes the contactors in accordance with the command to connect or disconnect battery 501 from the PDU 508. Such a command can be received by PDU controller 565 from VCU 506 via CAN bus 507 and CAN connector 509. Similarly, information indicating the state of HV1+ contactor 515 and HV1− contactor 516 can be transmitted to VCU 506 via CAN bus 507 and CAN connector 509.

In some examples, where a second battery 502 is included in system 500, PDU controller 565 is communicatively coupled to HV2+ contactor 525 and HV2− contactor 526 through one or more signal interconnects for providing commands to HV2+ contactor 525 and HV2− contactor 526 and receiving state information from HV2+ contactor 525 and HV2− contactor 526. A command from the PDU controller 565 to HV2+ contactor 525 and HV2− contactor 526 opens or closes the contactors in accordance with the command to connect or disconnect battery 502 from the PDU 508. Such a command can be received by PDU controller 565 from VCU 506 via CAN bus 507 and CAN connector 509. Similarly, information indicating the state of HV2+ contactor 525 and HV2− contactor 526 can be transmitted to VCU 506 via CAN bus 507 and CAN connector 509.

In some examples, where a third battery 503 is included in system 500, PDU controller 565 is communicatively coupled to HV3+ contactor 535 and HV3− contactor 536 through one or more signal interconnects for providing commands to HV3+ contactor 535 and HV3− contactor 536 and receiving state information from HV3+ contactor 535 and HV3− contactor 536. A command from the PDU controller 565 to HV3+ contactor 535 and HV3− contactor 536 opens or closes the contactors in accordance with the command to connect or disconnect battery 503 from the PDU 508. Such a command can be received by PDU controller 565 from VCU 506 via CAN bus 507 and CAN connector 509. Similarly, information indicating the state of HV3+ contactor 535 and HV3− contactor 536 can be transmitted to VCU 506 via CAN bus 507 and CAN connector 509.

The PDU controller 565 is communicatively coupled to the motor contactors motor+contactor 545 and motor− contactor 546 through one or more signal interconnects for providing commands to motor+ contactor 545 and motor− contactor 546 and receiving state information from motor+ contactor 545 and motor− contactor 546. A command from the PDU controller 565 to motor+ contactor 545 and motor− contactor 546 opens or closes the contactors in accordance with the command to connect or disconnect motor 504 from the PDU 508. Such a command can be received by PDU controller 565 from VCU 506 via CAN bus 507 and CAN connector 509. Similarly, information indicating the state of motor+ contactor 545 and motor− contactor 546 can be transmitted to VCU 506 via CAN bus 507 and CAN connector 509.

The PDU controller 565 in conjunction with VCU 506 facilitates the handling and recovery of faults due to disconnection of powertrain components from PDU 508. When a battery connector (e.g., HV1+ 512, HV1− 513) for a particular battery is disconnected during operation, the corresponding battery contactors (e.g., HV1+ contactor 515, HV1− contactor 516) in PDU 508 open due to the interruption in the HVIL loop. Based on state information provided by PDU 508, VCU 506 will identify this as a HVIL failure (contactor state different from the command). Via the CAN bus, VCU 506 instructs the battery to go in IDLE state and asks the boater to fix the issue. If the issue is fixed and acknowledged by the boater, VCU 506 instructs PDU 508 to close the batter contactor and, if no issue is detected, instructs the battery to enter the ACTIVE state.

When a motor connector is removed, the motor contactors (contactors 545, 546) in PDU 508 open due to the interruption in the HVIL loop. Based on state information provided by PDU 508, VCU 506 will identify this as a HVIL failure (contactor state different from the command). Via the CAN bus, VCU 506 instructs PDU 508 to open the motor contactors and asks for the boater to fix the issue. If the issue is fixed and acknowledged by the boater, VCU 506 instructs PDU 508 to close the MOT contactors.

When a DCDC connector is removed, the motor contactors and all battery contactors (for any connected battery) open within PDU 508. Based on state information provided by PDU 508, VCU 506 will identify this as a HVIL failure (contactor state different from the command). VCU 506 instructs PDU 508 to open all contactors within PDU 508 and asks the boater to fix the issue. If the issue is fixed and acknowledged by the boater, VCU 506 instructs PDU 508 to close the battery and motor contactors and instructs the batteries to enter in ACTIVE state.

When a power line couples the charging port of the vessels to a shore power inlet and the vessel receives power, the charger wakes up and starts sending frames over the CAN bus. VCU 506 detects the presence of the charger and asks for the motor to be in NEUTRAL (no speed, no torque, no current). VCU 506 instructs PDU 508 to open the motor contactors. If the power line is removed from the shore power inlet, then the charger is no longer powered and stops sending CAN frames. VCU 506 detects the end of charge and instructs PDU 508 to close the motor contactors. In some examples, these operations are done with the batteries in ACTIVE mode, without requesting the batteries to leave this state.

In view of the foregoing, it will be appreciated that system 500 provides independent and parallel control and fault handling of multiple powertrain components via PDU 508. When a particular powertrain component is disconnected from PDU 508 or any other failure is detected by the corresponding HVIL loop, the contactors corresponding to that component are automatically opened in PDU 508 without reliance on software or other logic. Opening of the contactor is automatically triggered via one or more HVIL relays that are coupled to the HVIL loop. When the DCDC converter is disconnected from PDU 508 or any other failure is detected by the HVIL loop between PDU 508 and DCDC converter 505, all contactors in PDU 508 are automatically opened without reliance on software or other logic. This prevents a free DCDC connector or cable from remaining hot. Opening of the contactors is automatically triggered via one or more HVIL relays that are coupled to the DCDC converter HVIL loop.

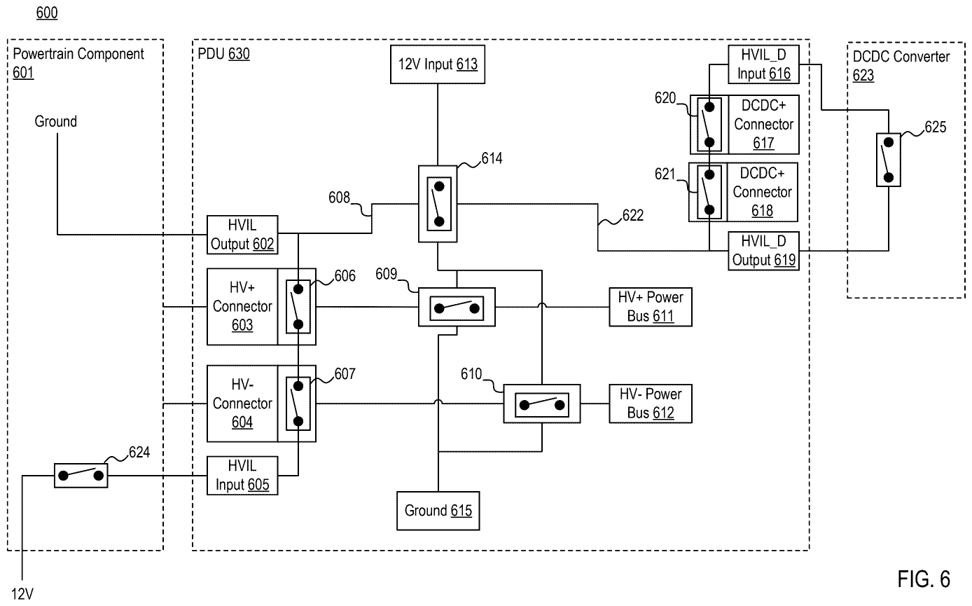

For further explanation, FIG. 6 sets forth block diagram of an example contactor disconnect system 600 for enhancing safety in an electric marine vessel using independent fault detection loops in a power distribution unit in accordance with at least one embodiment of the present disclosure. The example of FIG. 6 demonstrates an example system 600 through which HV contactors are automatically opened in response to independently detecting either a disconnect with a powertrain component (e.g., a motor or battery) or with a DCDC converter. The system 600 of FIG. 6 includes a powertrain component 601. For example, the powertrain component can be a battery such as HV battery 103 of FIGS. 1A and 1C, battery pack 300 of FIGS. 3 and 4, or batteries 501, 502, 503 of FIG. 5. The powertrain component 601 can also be a motor such as marine propulsion system 102 of FIGS. 1A and 1B or motor 504 of FIG. It will be appreciated that powertrain component 601 may be other types of components not specifically identified here and which are couplable to a PDU.

The system 600 of FIG. 6 also includes a PDU 630 coupled to the powertrain component 601. For example, PDU 630 can be PDU 104 of FIGS. 1A, 1D, and 4 or PDU 508 of FIG. 5. PDU 630 includes HV+ connector 603 and HV− connector 604 for supplying or receiving power to/from powertrain component 601. For example, where powertrain component 601 is a battery, HV+ connector 603 and HV− connector 604 are coupled respectively to HV+ and HV− connectors of a battery through which power is received from the battery. Where powertrain component 601 is a motor, HV+ connector 603 and HV− connector 604 are coupled to HV+ and HV− connectors of the motor for supplying power to the motor. As particular parts of the powertrain component 601 are unnecessary to describe the contactor disconnect system 600 with respect to PDU 630, those parts of powertrain component 601 are omitted from the drawings for ease of explanation.

PDU 630 also includes an HV+ contactor 609 that opens and closes to disconnect and connect the HV+ connector 603 to an HV+ power bus 611 of PDU 630. PDU 630 also includes and HV− contactor 610 that opens and closes to disconnect and connect the HV− connector 604 to an HV− power bus 612 of PDU 630. HV+ contactor 609 and HV− contactor 610 may be relays or other electromechanical switching devices. It will be appreciated that, in some variations, HV+ contactor 609 and HV− contactor 610 can be integrated into a unified contactor device. In some examples, HV+ contactor 609 and HV− contactor 610 receive a 12V control voltage that controls the actuation of the switch(es) of HV+ contactor 609 and HV− contactor 610. For example, HV+ contactor 609 and HV− contactor 610 may be coupled to a 12V input terminal 613 and ground terminal 615 of PDU 630. In some examples, the 12V control voltage supplies power to a solenoid actuator of the HV+ contactor 609 and HV− contactor 610. As such, when no power supplied to HV+ contactor 609 and HV− contactor 610, the switches of HV+ contactor 609 and HV− contactor 610 remain in an open state (i.e., a non-conductive state). Although a 12V control voltage is described, it will be appreciated that any voltage could be used to provide actuation power to HV+ contactor 609 and HV− contactor 610.

PDU 630 implements part of an HVIL loop 608 with powertrain component 601. In some examples, powertrain component 601 uses a 12V power source to provide an HVIL signal to an HVIL input connector 605 of PDU 630. The HVIL signal can be interrupted by one or more HVIL contactors 624 in powertrain component 601. For example, the HVIL contactor 624 may open in response to a cable disconnect from powertrain component 601. Within PDU 630, the HVIL loop 608 passes to an HVIL output connector 602 through one or more HVIL contactors 606, 607 that are closed by connecting a cable to HV+ connector 603 and HV− connector 604 and that are opened when a cable is disconnected from HV+ connector 603 and HV− connector 604. HVIL contactor 606 may be integrated with or coupled to HV+ connector 603 such that HVIL contactor 606 opens when a cable is disconnected from HV+ connector 603. HVIL contactor 607 may be integrated with or coupled to HV− connector 604 such that HVIL contactor 607 opens when a cable is disconnected from HV− connector 604. As shown in the example of FIG. 6, the HVIL loop 608 passes from HVIL input connector 605 to HVIL contactor 607 to HVIL contactor 606 to HVIL output connector 602. Powertrain component 601 receives the signal from HVIL output connector 602 of PDU 630 to close the HVIL loop 608.

PDU 630 is also coupled to a DCDC converter 623 of system 600 via DCDC+ connector 617 and DCDC− connector 618 of PDU 630. DCDC+ connector 617 provides a positive voltage from HV+ power bus 611 to an HV connector of DCDC converter 623. DCDC− connector 618 provides a negative voltage from HV− power bus 612 to an HV connector of DCDC converter 623. PDU 630 implements part of HVIL_D loop 622 with DCDC converter 623. Like powertrain component 601, DCDC converter 623 includes one or more HVIL contactors 625. For example, the HVIL contactor 625 may open in response to a cable disconnect from DCDC converter 623. Within PDU 630, the HVIL_D loop 622 is received at HVIL_D input connector 616 and passes to HVIL_D output connector 619 through one or more HVIL contactors 620, 621 that are closed by connecting a cable to DCDC+ connector 617 and DCDC− connector 618 and that are opened when a cable is disconnected from DCDC+ connector 617 and DCDC− connector 618. HVIL contactor 620 may be integrated with or coupled to DCDC+ connector 617 such that HVIL contactor 620 opens when a cable is disconnected from DCDC+ connector 617. HVIL contactor 621 may be integrated with or coupled to DCDC− connector 618 such that HVIL contactor 621 opens when a cable is disconnected from DCDC− connector 618. As shown in the example of FIG. 6, the HVIL loop 622 passes from HVIL_D input connector 616 to HVIL contactor 620 to HVIL contactor 621 to HVIL_D output connector 619. DCDC converter 623 receives the signal from HVIL_D output connector 619 of PDU 630 to close the HVIL loop 622.

PDU 630 also includes a disconnect relay 614 for connecting and disconnecting the 12V power supply from 12V input terminal 613 to HV+ contactor 609 and HV− contactor 610. Disconnect relay 614 is actuated in response to HVIL loop 608 and HVIL_D loop 622. When HVIL loop 608 is interrupted due to an HVIL contactor opening in PDU 630 or powertrain component 601, disconnect relay 614 opens to disconnect the actuator power supply to HV+ contactor 609 and HV− contactor 610. Disconnection of the actuator power supply opens HV+ contactor 609 and HV− contactor 610 to prevent the electrical coupling of HV+ connector 603 and HV− connector 604 to HV+ power bus 611 and HV− power bus 612. When HVIL_D loop 622 is interrupted due to an HVIL contactor opening in PDU 630 or DCDC converter 623, disconnect relay 614 opens to disconnect the actuator power supply to HV+ contactor 609 and HV− contactor 610. Disconnection of the actuator power supply opens HV+ contactor 609 and HV− contactor 610 to prevent the electrical coupling of HV+ connector 603 and HV− connector 604 to HV+ power bus 611 and HV− power bus 612, respectively. In this way, HV contactors in the PDU are opened or remain open in the event of a HVIL fault detection with respect to a particular power train component 601 or the DCDC converter 623. That is, the HV contactors 609 ,610 are opened when there is a fault in the connection to the DCDC converter 623, even if there is no fault in the connection to the powertrain component 601. The contactor disconnect system 600 can be applied to all contactors in PDU 630. In some examples, contactor disconnect system 600 is integrated in system 500 of FIG. 5, such that all contactors 515, 516, 525, 526, 535, 536, 545, 546 in PDU 508 open when HVIL_D loop 557 is interrupted. Otherwise, pairs of contactors are opened independently in response to a fault based on the independent HVIL loop with which they are connected.

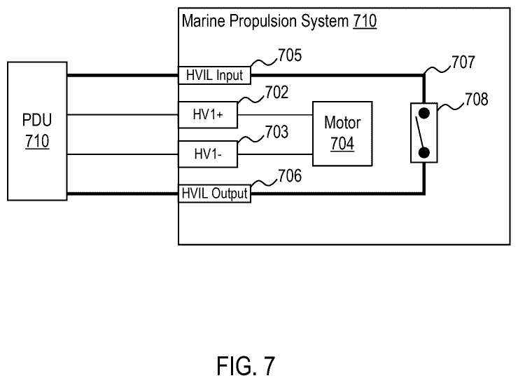

For further explanation, FIG. 7 sets forth an example marine propulsion system 700 for enhancing safety in an electric marine vessel using independent fault detection loops in a power distribution unit in accordance with at least one embodiment of the present disclosure. Marine propulsion system includes an HV+ connector 702, an HV− connector 703, and a motor 704 coupled to the HV+ connector 702 and HV− connector 703 for receiving power to the motor 704 from PDU 710. For example, PDU 710 may be PDU 104 of FIGS. 1A, 1D, and 4; PDU 508 of FIG. 5; or PDU 630 of FIG. 6. Marine propulsion system 700 also includes an HVIL input connector 705 and an HVIL output connector 706 for implementing an HVIL loop 707 with PDU 710. Marine propulsion system also includes at least one HVIL contactor 708 that is configured to open in response to detecting a fault. For example, HVIL contactor 708 may open upon detecting a disconnection of a cable from HV+ connector 702 or HV− connector 703. The interruption in the HVIL loop 707 by HVIL contactor 708 is detectable by PDU 710 as an HVIL fault. In response to detecting the HVIL fault, PDU 710 opens motor contactor in PDU 710.

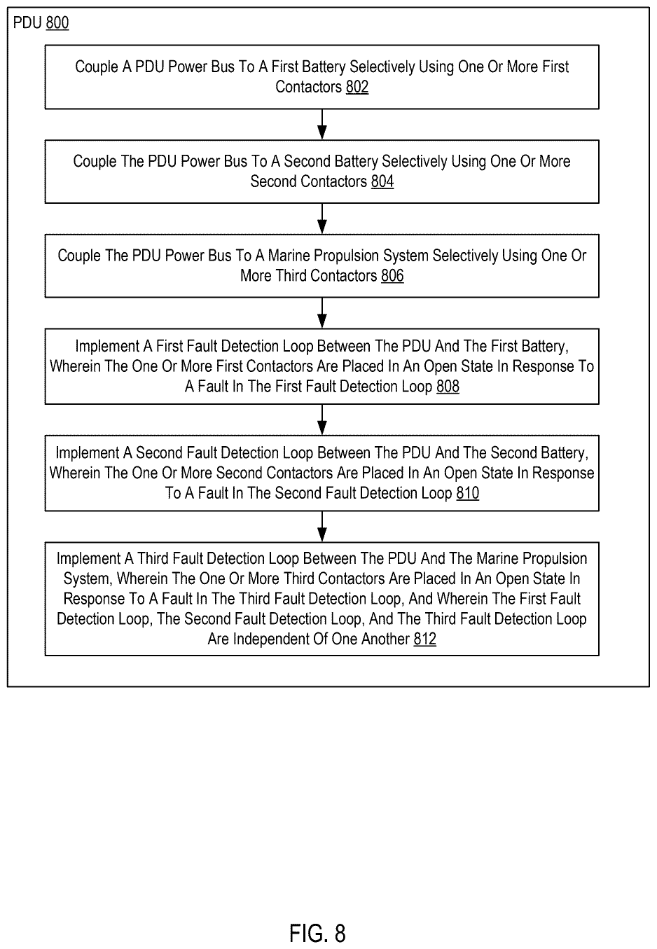

For further explanation, FIG. 8 sets forth a flow chart of an example method for enhancing safety in an electric marine vessel using independent fault detection loops in a power distribution unit in accordance with at least one embodiment of the present disclosure. The example of FIG. 8 includes a PDU 800, which can be PDU 104 of FIGS. 1A, 1D, and 4; PDU 508 of FIG. 5; PDU 630 of FIG. 6; or PDU 710 of FIG. 7. The method of FIG. 8 includes coupling 802 a PDU power bus to a first battery selectively using one or more first contactors. In some examples, coupling 802 a PDU power bus to a first battery selectively using one or more first contactors is carried out as shown in FIG. 5, by coupling HV+ power bus 560 and HV− power bus 561 to HV1+ connector 512 and HV1− connector 513 via HV1+ contactor 515 and HV1− contactor 516, respectively. HV1+ contactor 515 and HV1− contactor 516 selectably open and close a circuit between HV+ power bus 560 and HV1+ connector 512 and between HV− power bus 561 and HV1− connector 513 in response to a command from a PDU controller or in response to fault detection. The HV1+ connector 512 and HV1− connector 513 are, in turn, connected to battery 501 via corresponding power cables.

The method of FIG. 8 also includes coupling 804 the PDU power bus to a second battery selectively using one or more second contactors. In some examples, coupling 804 the PDU power bus to a second battery selectively using one or more second contactors is carried out as shown in FIG. 5, by coupling HV+ power bus 560 and HV− power bus 561 to HV2+ connector 522 and HV2− connector 523 via HV2+ contactor 525 and HV2− contactor 526, respectively. HV2+ contactor 525 and HV2− contactor 526 selectably open and close a circuit between HV+ power bus 560 and HV2+ connector 522 and between HV− power bus 561 and HV2− connector 523, respectively, in response to a command from a PDU controller or in response to fault detection. The HV2+ connector 522 and HV1− connector 523 are, in turn, connected to battery 502 via corresponding power cables.

The method of FIG. 8 also includes coupling 806 the PDU power bus to a marine propulsion system selectively using one or more third contactors. In some examples, coupling 806 the PDU power bus to a marine propulsion system selectively using one or more third contactors is carried as shown in FIG. 5, by coupling HV+ power bus 560 and HV− power bus 561 to motor+ connector 542 and motor− connector 543 via motor+ contactor 545 and motor− contactor 546, respectively. Motor+ contactor 545 and motor− contactor 546 selectably open and close a circuit between HV+ power bus 560 and motor+ connector 542 and between HV− power bus 561 and motor− connector 543, respectively, in response to a command from a PDU controller or in response to fault detection. The motor+ connector 542 and motor− connector 543 are, in turn, connected to motor 504 via corresponding power cables.

The method of FIG. 8 also includes implementing 808 a first fault detection loop between the PDU and the first battery, wherein the one or more first contactors are placed in an open state in response to a fault in the first fault detection loop. In some examples, implementing 808 a first fault detection loop between the PDU and the first battery is carried out as shown in FIG. 5 by HVIL loop 517 between PDU 508 and battery 501 and/or as shown in FIG. 6 by HVIL loop 608 between PDU 630 and powertrain component 601.

The method of FIG. 8 also includes implementing 810 a second fault detection loop between the PDU and the second battery, wherein the one or more second contactors are placed in an open state in response to a fault in the second fault detection loop. In some examples, implementing 810 a second fault detection loop between the PDU and the second battery is carried out as shown in FIG. 5 by HVIL loop 527 between PDU 508 and battery 502 and/or as shown in FIG. 6 by HVIL loop 608 between PDU 630 and powertrain component 601.

The method of FIG. 8 also includes implementing 812 a third fault detection loop between the PDU and the marine propulsion system, wherein the one or more third contactors are placed in an open state in response to a fault in the third fault detection loop, and wherein the first fault detection loop, the second fault detection loop, and the third fault detection loop are independent of one another. In some examples, implementing 812 a third fault detection loop between the PDU and the marine propulsion system is carried out as shown in FIG. 5 by HVIL loop 547 between PDU 508 and motor 504 and/or as shown in FIG. 6 by HVIL loop 608 between PDU 630 and powertrain component 601.

The first fault detection loop, second fault detection loop, and third fault detection loop are independent of one another. When a fault is detected by the first fault detection loop, only the first contactors of the PDU 800 are opened in response. No other contactors (e.g., the second contactors or third contactors) are opened. As such, when only a single battery is disconnected, the other battery remains electrically connected to the PDU power bus. When a fault is detected by the second fault detection loop, only the second contactors of the PDU 800 are opened in response. No other contactors (e.g., the first contactors or third contactors) are opened. When a fault is detected by the third fault detection loop, only the third contactors of the PDU 800 are opened in response. As such, when the marine propulsion system is disconnected from the PDU 800, the batteries can remain electrically connected to the PDU power bus. When a fault is detected in a fault detection loop, corresponding contactors are opened or maintained in the open state without the need for any software or logic control system.

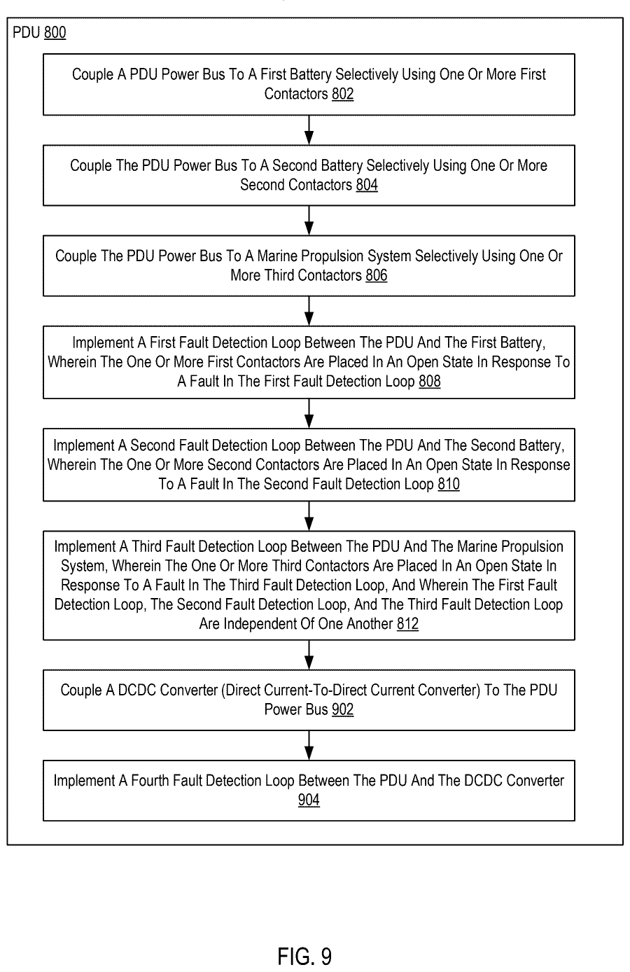

For further explanation, FIG. 9 sets forth another example method for enhancing safety in an electric marine vessel using independent fault detection loops in a power distribution unit in accordance with at least one embodiment of the present disclosure. The method of FIG. 9 extends the method of FIG. 8 in that the method of FIG. 9 includes coupling 902 a DCDC converter to the PDU power bus. In some examples, coupling 902 a DCDC converter to the PDU power bus is carried out as shown in FIG. 5, by connecting DCDC converter 505 to HV+ power bus 560 and HV− power bus 561 via DCDC+ connector 552 and DCDC− connector 553, respectively.

The method of FIG. 9 also includes implementing 904 a fourth fault detection loop between the PDU and the DCDC converter. In some examples, implementing 904 a fourth fault detection loop between the PDU and the DCDC converter is carried out as shown in FIG. 5 by HVIL_D loop 557 between PDU 508 and DCDC converter 505 and/or as shown in FIG. 6 by HVIL_D loop 622 between PDU 630 and DCDC converter 623. In some examples, in response to detecting a fault in the fourth fault detection loop, the first contactors, the second contactors, and the third contactors are placed in the open state (i.e., opened or maintained in the open state). As such, the first battery, the second battery, and the marine propulsion system are disconnected by contactors internal to PDU 800. In other words, in some examples, all PDU contactors open in response to detecting a fault in the fourth fault detection loop.

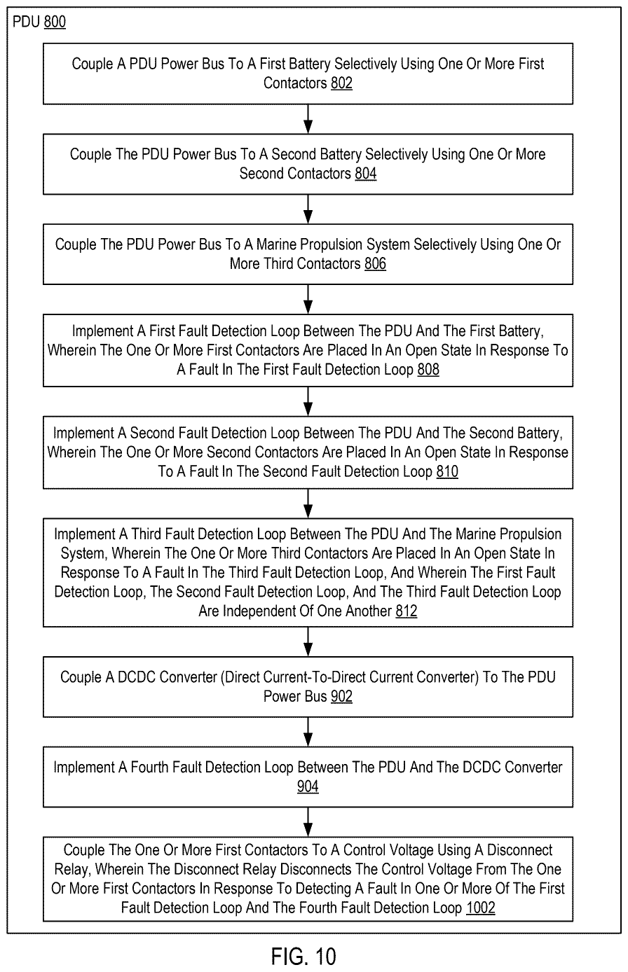

For further explanation, FIG. 10 sets forth another example method for enhancing safety in an electric marine vessel using independent fault detection loops in a power distribution unit in accordance with at least one embodiment of the present disclosure. The method of FIG. 10 extends the method of FIG. 9 in that the method of FIG. 10 includes coupling 1002 the one or more first contactors to a control voltage using a disconnect relay, wherein the disconnect relay disconnects the control voltage from the one or more first contactors in response to detecting a fault in one or more of the first fault detection loop and the fourth fault detection loop. In some examples, coupling 1002 the one or more first contactors to a control voltage using a disconnect relay is carried out as shown in FIG. 6, where disconnect relay 614 disconnects a control/actuator voltage supply to contactors 609, 610 in response to detecting a fault in either HVIL loop 608 or HVIL_D loop 622.

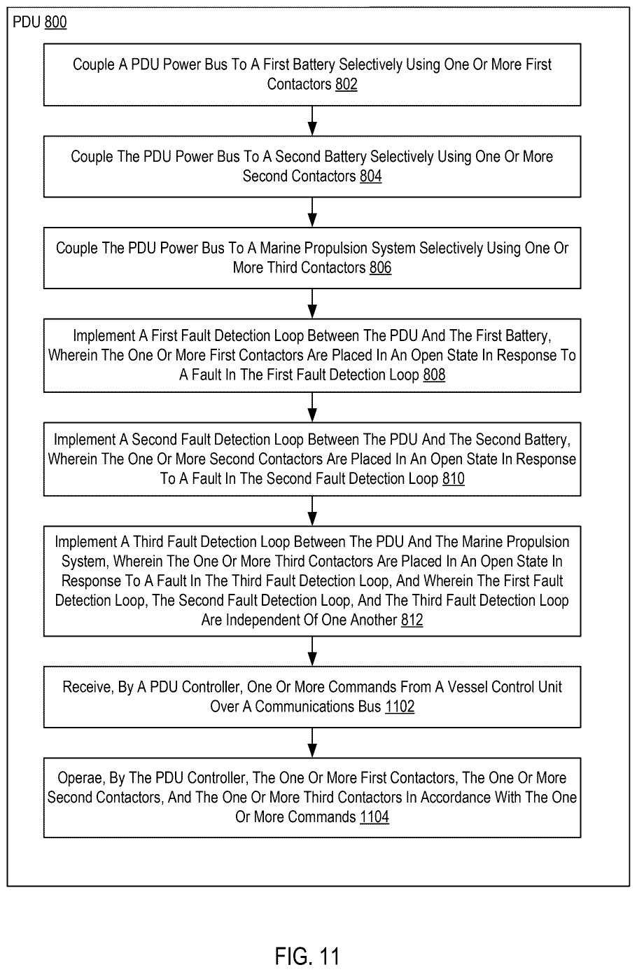

For further explanation, FIG. 11 sets forth another example method for enhancing safety in an electric marine vessel using independent fault detection loops in a power distribution unit in accordance with at least one embodiment of the present disclosure. The method of FIG. 11 extends the method of FIG. 8 in that the method of FIG. 11 includes receiving 1102, by a PDU controller, one or more commands from a vessel control unit over a communications bus. In some examples, PDU controller receives commands from a VCU as described above, with particular reference to PDU 508 and VCU 506 in FIG. 5 as described above.

The method of FIG. 11 also includes operating 1104, by the PDU controller, the one or more first contactors, the one or more second contactors, and the one or more third contactors in accordance with the one or more commands. As described above, during normal operation, the PDU controller opens and closes contactors in the PDU based on commands received from the VCU over a communications bus such as the CAN bus. For example, in response to a command from the VCU to close the motor contactors, the PDU utilizes a control signal to close the motor+ and motor− contactors.

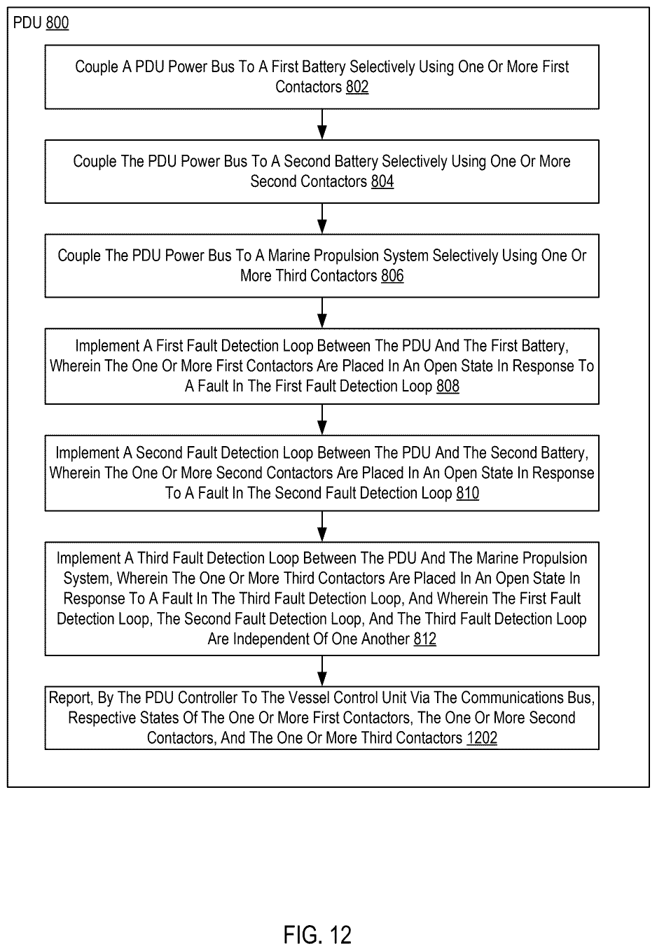

For further explanation, FIG. 12 sets forth another example method for enhancing safety in an electric marine vessel using independent fault detection loops in a power distribution unit in accordance with at least one embodiment of the present disclosure. The method of FIG. 12 extends the method of FIG. 11 in that the method of FIG. 12 includes reporting 1202, by the PDU controller to the vessel control unit via the communications bus, respective states of the one or more first contactors, the one or more second contactors, and the one or more third contactors. As described above, the PDU controller reports the states (open/closed) of the contactors in the PDU to the VCU via the CAN bus.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A PDU (Power Distribution Unit) of an electric marine vessel, the PDU comprising:
one or more first contactors configured to electrically couple a PDU power bus to a first battery;
one or more second contactors configured to electrically couple the PDU power bus to a second battery;
one or more third contactors configured to electrically couple the PDU power bus to a marine propulsion system;
a first fault detection loop implemented by the PDU and the first battery, wherein the one or more first contactors are placed in an open state in response to a fault in the first fault detection loop;
a second fault detection loop implemented by the PDU and the second battery, wherein the one or more second contactors are placed in an open state in response to a fault in the second fault detection loop; and
a third fault detection loop implemented by the PDU and the marine propulsion system, wherein the one or more third contactors are placed in an open state in response to a fault in the third fault detection loop, and wherein the first fault detection loop, the second fault detection loop, and the third fault detection loop are independent of one another.

2. The PDU of claim 1, wherein placing a particular contactor in the open state in response to detecting a fault in a corresponding fault detection loop is performed automatically without a control system.

3. The PDU of claim 1, wherein only the one or more first contactors are placed in the open state in response to detecting a fault in the first fault detection loop;
wherein only the one or more second contactors are placed in the open state in response to detecting a fault in the second fault detection loop; and
wherein only the one or more third contactors are placed in the open state in response to detecting a fault in the third fault detection loop.

4. The PDU of claim 1 further comprising:
a DCDC converter (direct current to direct current converter) electrically coupled to the PDU power bus; and
a fourth fault detection loop implemented by the PDU and the DCDC converter.

5. The PDU of claim 4, wherein the one or more first contactors, the one or more second contactors, and the one or more third contactors are opened in response to detecting a fault in the fourth fault detection loop.

6. The PDU of claim 5, wherein all contactors in the PDU are opened in response to detecting a fault in the fourth fault detection loop.

7. The PDU of claim 6, wherein the fourth fault detection loop is further coupled to an emergency stop switch operable by a user.

8. The PDU of claim 4 further comprising:
a disconnect relay configured to electrically couple the one or more first contactors to a control voltage; wherein the disconnect relay disconnects the control voltage from the one or more first contactors in response to detecting a fault in one or more of the first fault detection loop and the fourth fault detection loop.

9. The PDU of claim 1 further comprising:
a PDU controller coupled to a communications bus, the PDU configured to:
receive one or more commands from a vessel control unit over the communications bus; and
operate the one or more first contactors, the one or more second contactors, and the one or more third contactors in accordance with the one or more commands.

10. The PDU of claim 8, wherein the PDU controller is configured to:
report, to the vessel control unit via the communications bus, respective states of the one or more first contactors, the one or more second contactors, and the one or more third contactors.

11. A method of enhancing safety in an electric marine vessel using a PDU (Power Distribution Unit), the method comprising:
coupling a PDU power bus to a first battery selectively using one or more first contactors;
coupling the PDU power bus to a second battery selectively using one or more second contactors;
coupling the PDU power bus to a marine propulsion system selectively using one or more third contactors;
implementing a first fault detection loop between the PDU and the first battery, wherein the one or more first contactors are placed in an open state in response to a fault in the first fault detection loop;
implementing a second fault detection loop between the PDU and the second battery, wherein the one or more second contactors are placed in an open state in response to a fault in the second fault detection loop; and
implementing a third fault detection loop between the PDU and the marine propulsion system, wherein the one or more third contactors are placed in an open state in response to a fault in the third fault detection loop, and wherein the first fault detection loop, the second fault detection loop, and the third fault detection loop are independent of one another.

12. The method of claim 11, wherein placing a particular contactor in the open state in response to detecting a fault in a corresponding fault detection loop is performed automatically without a control system.

13. The method of claim 11, wherein only the one or more first contactors are placed in the open state in response to detecting a fault in the first fault detection loop;
wherein only the one or more second contactors are placed in the open state in response to detecting a fault in the second fault detection loop; and
wherein only the one or more third contactors are placed in the open state in response to detecting a fault in the third fault detection loop.

14. The method of claim 11 further comprising:
coupling a DCDC converter (Direct Current-to-Direct Current converter) to the PDU power bus; and
implementing a fourth fault detection loop between the PDU and the DCDC converter.

15. The method of claim 14, wherein the one or more first contactors, the one or more second contactors, and the one or more third contactors are opened in response to detecting a fault in the fourth fault detection loop.

16. The method of claim 15, wherein all contactors in the PDU are opened in response to detecting a fault in the fourth fault detection loop.

17. The method of claim 14 further comprising:
coupling the one or more first contactors to a control voltage using a disconnect relay, wherein the disconnect relay disconnects the control voltage from the one or more first contactors in response to detecting a fault in one or more of the first fault detection loop and the fourth fault detection loop.

18. The method of claim 11 further comprising:
receiving, by a PDU controller, one or more commands from a vessel control unit over a communications bus; and
operating, by the PDU controller, the one or more first contactors, the one or more second contactors, and the one or more third contactors in accordance with the one or more commands.

19. The method of claim 17 further comprising:
reporting, by the PDU controller to the vessel control unit via the communications bus, respective states of the one or more first contactors, the one or more second contactors, and the one or more third contactors.

20. An electric marine vessel comprising:
a first battery;
a second battery;
a marine propulsion system; and
a PDU (Power Distribution Unit) including:
one or more first contactors configured to electrically couple a PDU power bus to the first battery;
one or more second contactors configured to electrically couple the PDU power bus to the second battery;
one or more third contactors configured to electrically couple the PDU power bus to the marine propulsion system;
a first fault detection loop implemented by the PDU and the first battery, wherein the one or more first contactors are placed in an open state in response to a fault in the first fault detection loop;
a second fault detection loop implemented by the PDU and the second battery, wherein the one or more second contactors are placed in an open state in response to a fault in the second fault detection loop; and
a third fault detection loop implemented by the PDU and the marine propulsion system, wherein the one or more third contactors are placed in an open state in response to a fault in the third fault detection loop, and wherein the first fault detection loop, the second fault detection loop, and the third fault detection loop are independent of one another.
